(19) United States
(12) Patent Application Publication
(10) Pub. No.: US 2003/0025933 A1
(43) Pub. Date: Feb. 6, 2003

(54) Image order processing system

(75) Inventors: Tsutomu Kimura, Kanagawa (JP); Takayuki Iida, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/201,251

(22) Filed: Jul. 24, 2002

(30) Foreign Application Priority Data
Aug. 1, 2001 (JP) 2001-233341

(51) Int. Cl. B41J 1/00; G06F 15/00

(52) U.S. Cl. 358/1.15; 358/1.18

(57) ABSTRACT

The present invention provides an image ordering system in which an environment for enabling easily printing ordering for unspecified image content can be simply realized. A user watching image content delivered from a content deliverer designates an image to be printed. Then, image specifying information for specifying the image is written into a scene marker possessed by the user. When the user performs printing ordering via a receiving machine, the image specifying information is read out from the scene marker and a thumbnail image provided from the content provider is displayed. When the order is designated, high quality image data is provided from the content provider to the image order processing device. Subsequently, the image order processing device transfers the data so as to ask a print finishing operator to perform a print finishing processing.

### BACKGROUND OF THE INVENTION

1. Field of the Invention

The present invention relates to an image order processing device and a method of processing image orders. In particular, the invention relates to an image order processing device for processing printing orders from customers, and an image order processing method which can be applied by to the image order processing device.

2. Description of the Related Art

Digitalization of image information sources is progressing, and high quality image content for impressing more sharply, such as a digital theater, a digitally broadcast television program and a network live performance relayed broadcast via an Internet have been delivered to users. An electronic signboard proposed in Japanese Patent Application Laid-Open (JP-A) No. 10-240205 is to be placed at equipment including stadiums, theaters, art museums and museums. In the equipment, scenes by which users were moved (e.g., a fine performance scene in sports event or a highlight scene in a play) are photographed and delivered by the electronic signboard as the image content.

In light of such circumstances, there is a demand for capturing, among various types of image content delivered by various delivery methods, a preferable scene or image, which impressed a user, and for storing this preferable scene or image as a photographic print. In order to satisfy the demand, it is necessary to realize an environment in which a user can order prints of any image content desired by a user from among the various types of image content delivered by the various types of delivery methods.

As a technique relating to the above-described, JP-A No. 10-171027 proposes a technique whereby a user designates a frame to be printed while watching a visual program, and sends online frame identifying information and printing order information to a print finishing operator. Then the print finishing operator produces prints by obtaining original image data of the frame to be printed from an image database of a broadcasting station.

Processes that receives printing orders from users and produce photographic prints in accordance with printing orders from users are mainly carried out by a large number of small scale print finishing operators all over the country. In order to realize the environment whereby a user can order prints of the any image content desired by a user. It is becoming necessary to provide various large-scale equipments. An example of this equipment is disclosed in JP-A No. 10-171027, which obtains the original image data of frame to be printed from the image database of the broadcasting station. Adding this equipment to an image printing system possessed by each print finishing operator would place a large economic burden on the print finishing operator and thus is not realistic.

However, in an environment wherein printing orders can only be received by a small number of specified operators, which have the above equipment added to their image printing systems, printing orders for image contents are very inconvenient and impose a large burden on the user when ordering prints or receiving prints that have been ordered.

### SUMMARY OF THE INVENTION

In view of the aforementioned fact, an object of the present invention is to provide an image order processing device, which can simply realize an environment for simply enabling ordering prints of unspecified image content, and a method of image order processing.

In order to accomplish the above object, in accordance with a first aspect of the invention, there is provided an image order processing device, for being connected to a network having an image ordering component, an image contents service system, a plurality of image printing systems, and an image processing system connected thereto, the image order processing device comprising: a reception and received order processing component for image printing ordering information from an image ordering component by a customer performing print ordering via the image ordering component; an image data obtaining component for obtaining, based on the image print ordering information, image data for the printing-ordered image from the image content service system; and a sending component for selecting an optimal image printing system from among the plurality of image printing systems and sending received order processing information expressing contents of the printing-ordered image and at least one of the obtained image data and print image data generated by the image processing component from the obtained image data.

The image order processing device of the first aspect is connected to a network. An image content service system and a plurality of image printing systems are also connected to the network. The network may be a network including public communication network such as the Internet. It is preferable that the network be configured by a dedicated line because it is possible to easily configure a network such that a large quantity of data can be transmitted stably and in a short time. Further, data leakage rarely occurs, so that high security can be obtained. Moreover, the network is not damaged by computer viruses or the like.

In accordance with the first aspect, the image content service system refers to as a system, which provides image data required at a time of printing any images of unspecified image content by unspecified delivery methods. The image content service system is configured so as to include, for example, electronic equipment such as a computer, which has a communication function, and to which a storage medium storing the image data is connected, and is possessed by a content provider for providing image content or a content deliverer delivering the image content provided by the content provider.

Further, the image printing system refers to as a system which receives image data for printing-ordered image and which has a function of performing a print finishing processing (i.e., a processing for storing the image in a recording medium) for the printing-ordered image by using the received image data. The image printing system is configured so as to include, for example, a computer having a communication function and is possessed by a plurality of image print finishing operators.

Examples of the image content delivered by the content provider include still or moving images photographed by a professional photographer, a news photographer, an amateur photographer or a camera without operator, still or moving images of television broadcasting or data broadcasting, any image content including moving images of network live performance delivered through a computer network and films. These image content are delivered by the content provider himself or the content deliverer, and are displayed on a display component such as an electronic signboard, a television, a computer, a portable telephone with a display section for displaying an image provided therein, or a screen equipment for playing a film.

In accordance with the first aspect, an order for printing a desired image from a customer who sees the image content displayed on a display component is made via an image ordering component connected to a network. When a printing order is made via the image ordering component, image printing order information is sent from the image ordering component. The image printing order information is received by a reception/received order processing component. An image data obtaining component obtains, on a basis of the image printing order information, the image data of the printing-ordered image from the image content service system connected to the network.

The send processing component selects an optimal image printing system (e.g., an image printing system which is preferable for a customer such as an image printing system designated by a customer or an image printing system nearest to the customer) from among a plurality of image printing systems connected to the network. Then, the image data obtained by the image obtaining component or the image printing data generated from the obtained image data by the image processing component (e.g., data facilitating a print finishing processing in the image printing system) and received order processing information which represents the contents of the received printing order are sent to the selected optimal image printing system.

In this way, in accordance with the first aspect, printing orders from customers are collected in the image order processing device relating to the invention. After to the data of the printing-ordered image being obtained, the data of the printing-ordered image (the obtained image data or the image printing data) is sent to the optimal image printing system. A print finishing processing is performed on the printing-ordered image in the optimized image printing system. Thus, when a print finishing processing is carried out in accordance with a printing order for the unspecified image content, an equipment, which performs a processing corresponding to the image data obtaining component of the invention, does not need to be added to each of the image printing systems. (If the send processing component sends the image printing data, the equipment for performing the processing corresponding to the image processing component does not need to be added to each of the image printing systems.) Further, a large burden for a customer is released when ordering a print and when receiving an ordered print. Consequently, in accordance with the first aspect, it is possible to easily realize an environment in which printing orders for unspecified image content are easily made.

The image ordering component relating to the invention can be configured to include electronic equipment (receiving machine) having a display section for displaying the information, an input section for inputting the information and a function of sending the information via the network to the image order processing device. Further, the receiving machine may be installed individually or may be provided at the display component for displaying the image content (e.g., an electronic signboard, a bi-directional television, a computer or a seat in a film theater). Further, a portable telephone can be configured to function as the receiving machine (in this case, the display section of the portable telephone functions as the display component). As a result, the receiving machine can be possessed by a customer.

In an aspect in which portable equipment, which includes at least the information storage component, is possessed by a customer, the receiving machine preferably has a function of reading out the information stored in the information storage component of the portable equipment. Thus, by writing in advance customer information (which will be described later) into the information storage component of the portable equipment, the receiving machine can easily obtain the customer information.

In the above aspect, the image ordering component relating to the invention may be configured so as to include a writing device which is provided at the display component for displaying the image content and has at least a function of writing the information into the information storage component of the portable equipment. In this case, when an order to print an image is designated by a customer, the information for identifying the printing-ordered image (which will be described later) is obtained and written into the information storage component of the portable equipment. Then, the receiving machine reads out the information. Thus, the receiving machine can obtain the information for specifying the printing-ordered image. When the writing device is not provided (in this case, the receiving machine is preferably provided at the display component), the receiving machine obtains the information.

In the first aspect, the reception/received order processing component performs at least one of fee informing processing for informing a customer of the fee for the printing order via the image ordering component and a settlement processing for settling a fee for the printing order. When the reception/received order processing component is configured so as to perform the above fee informing processing, an equipment for calculating the fee for the printing order need not be added to each of the image printing systems. When the reception/received order processing component is configured so as to perform the above settlement processing, equipment for settling a fee for printing order needs not to be added to each of the image printing systems. Accordingly, equipment to be added to each of the image printing systems can be simplified.

In the first aspect, the image printing order information includes customer information, which indicates a customer who ordered printing, and the reception/received order processing component stores the customer information included in the received image printing order information in a customer information storage component. Thus, based on the customer information stored in the customer information storage component, customer management can be performed in the image order processing device relating to the invention. The customer information may be configured so as to include at least one of an ID for identifying a customer, a customer name, a customer address and customer contact information (any one of a telephone number, a FAX number, and an electronic mail address).

In the first aspect, a copyright managing component for performing a processing for managing the copyright of the printing-ordered image is preferably provided. As a result, equipment for performing a processing for managing the copyright of the printing-ordered image need not be added to each of the image printing systems and thus the equipment to be added to each of the image printing systems can be simplified.

The copyright managing component may perform a copyright fee settling processing in which compensation which should be paid to each of copyright holders depending on a quantity of each of the printing-ordered images used or on usage of the printing-ordered image is added during a predetermined period of time, and the compensation for image usage is paid to the copyright holder on a basis of the added information.

In the first aspect, the image data obtaining component may be configured so as to obtain only original image data of the printing-ordered image. Nevertheless, the original image data of the printing-ordered image and the thumbnail image data (i.e., image data obtained by reducing a resolution of the original image data) are obtained, and the reception/received order processing component sends the thumbnail image data obtained by the image data obtaining component to the image ordering component. Thus, the reception/received order processing component instructs the image ordering component-to perform a processing wherein a customer re-confirms the printing-ordered image.

As the thumbnail image data that is sent to the image ordering component, the image ordering component can display, on a basis of the received thumbnail image data, the thumbnail image of the printing-ordered image on the display component. By using the displayed thumbnail image, the processing for a customer to re-confirm the printing-ordered image can be performed. Thus, the possibility of a customer incorrectly designating the image to be printed can be reduced. When a customer desires to edit or to synthesize the image (when a user desires to produce a New Year's card or a calendar by enlarging or decreasing the image and synthesizing the resultant image with a predetermined template), a customer can easily designate the editing or the synthesis of the image. Further, by using the thumbnail image data, the image ordering component can display a result of the editing or the synthesis as an image.

Further, in accordance with the first aspect, the image data obtaining component preferably selects, based on the information included in the image printing order information for specifying the printing-ordered image, the image content service system that stores the data of the ordered image among a plurality of image content serve systems connected to the network, and specifies the printing-ordered image. Accordingly, even in an environment in which printing orders for images of unspecified image content might be made from customers, the printing-ordered image can be easily specified and the data of the image can be easily obtained.

The information for specifying the printing-ordered image includes one of the information for identifying the content provider or the content deliverer, the information for identifying the display component which displays the image content ordered to be printed, the information which indicates a date of broadcasting and a program of television broadcasting or data broadcasting, the time information or time code for identifying the printing-ordered image in moving images or a film as the image content (identifying information attached to each frame of moving images: for example, in a case of moving images shot by a video camera, a subject is shot at a rate of 30 frames/second and a time code is allocated to each of 30 frames) and the information for identifying a delivery end delivering the image content via a computer network. The image ordering component may be configured so as to automatically obtain the information and attach the same to the image print information.

In accordance with the first aspect, the image data obtaining component preferably stores the obtained image data in the image data storage component. Consequently, if the image ordered by a customer to be printed is an image that has been ordered to be printed before, the image data obtaining component reads out the image data of the printing-ordered image from the image data storage component, so that the image data can be obtained. Thus, an amount of communication with the image content service system can be reduced.

In accordance with the first aspect, the image data obtained by the image data obtaining component may be the image data subjected to at least one of compression and encryption. In this case, the image data obtaining component performs at least one of a decompression of obtained compressed image data and a decoding of obtained encrypted image data. When the compressed image data is obtained and then decompressed, a time required for communication in order to obtain the image data can be reduced and an amount of communication with the image content service system can be reduced.

When the encrypted image data is obtained and then decoded, even if the network between the image order processing device relating to the invention and the image content service system is a network with low security, and the image data obtained by the image obtaining component is leaked to the third party, it is difficult for the third party receiving the data to maliciously use the data. Thus, the copyright of the image data can be protected. Accordingly, either reduction in an amount of communication with the image content service system or protect of the copyright of the obtained image data can be satisfied. Equipment for performing the above-described processing need not be added to each of a plurality of image printing systems. As a result, equipment that is to be added to each of the image printing systems can be further simplified.

Further, in accordance with the first aspect, the image processing component preferably performs at least one of resolution conversion and image processing for image quality enhancement upon the image data obtained by the image data obtaining component so as to generate the image printing data. Accordingly, equipment for performing the image processing for resolution conversion or image quality enhancement need not be added to each of a plurality of image printing systems. As a result, equipment to be added to each of the image printing systems can be further simplified.

In accordance with the first aspect, the image processing component performs at least one of editing of the image data obtained by the image data obtaining component and composition thereof depending on the contents of the received printing order so as to generate the image printing data. Accordingly, an equipment for editing or synthesizing the image data need not be added to each of a plurality of image printing systems. As a result, equipment to be added to each of the image printing systems can be further simplified.

In accordance with the first aspect, the send processing component preferably performs at least one of a compression and an encryption on the image data to be sent to the selected optimal image printing system. When the image data is compressed, a time required to send the image data to the image print data can be reduced, and an amount of communication to the image printing system can also be reduced. When the image data is encrypted, even if the network between the image order processing device relating to the invention and the image printing system is a network with low security, and the image data obtained by the image obtaining component is leaked to the third party, it is difficult for the third party receiving the data to maliciously use the data. Thus, the copyright of the image data can be protected.

Although equipment for performing at least one of decompression of the received compressed image data and decoding of the encrypted image data must be added to the image printing systems, at least one of reduction in an amount of communication to the image printing system and protect of the copyright of the sent image data can be satisfied.

In accordance with a second aspect of the invention, there is provided an image order processing method comprising the steps of: (a) connecting each of at least one of a plurality of image content service systems possessed by at least one of a plurality of content providers and a plurality of content deliverers and a plurality of image printing systems possessed by a plurality of image print finishing operators an image order processing device via a network; (b) making the image order processing device gather all printing orders ordered by customers watching the image content, which is delivered by one of the content provider and the content deliverer, through the image ordering component connected to the network to the image order processing device by sending, for each time a printing order occurs, the image printing order information containing the information for specifying the printing-ordered image from the image ordering component; and (c) in the image order processing device, obtaining image data for the printing-ordered image by selecting an image contents service system, which is storing ordered image data and specifying a printing-ordered image, selecting the optimal image printing system among the plurality of image printing systems, and making an image print finisher processing the optimal image printing system print the printing-ordered image by sending received order processing information which expresses contents of a received printing order and at least one of the obtained image data and printing image data generated from the obtained image data to the selected optimal image printing system. Thus, similar to the first aspect, the environment in which printing orders for unspecified image content can be easily made can be realized.

In accordance with the second aspect, the image printing order information may include at least one of operator designating information which represents a specified image print finishing operator designated by a customer via the image ordering component and customer information which represents the customer who ordered prints, and at least one of the image printing system possessed by the image print finishing operator expressed by the operator designating information and the image printing system possessed by the image print finishing operator nearest to the customer, which is selected on a basis of the customer information, is selected as the optimal image printing system. Thus, the image printing system, which is optimal for a customer, can be selected with high precision.

In accordance with the second aspect, the image content delivered by one of the content provider and the content deliverer may be one of still images and moving images photographed by one of a professional photographer, a news photographer, an amateur photographer and a camera without operator, still images and moving images of one of television broadcasting and data broadcasting, any image content including moving images of network live performance delivered through a computer network and films, and the image of the image content may be ordered to be printed by a customer.

In accordance with the second aspect, the information for specifying the printing-ordered image may comprise at least one of information for identifying at least one of the content provider and the content deliverer, the information for identifying a display component which displays the printing ordered image content, information indicating a date of broadcasting and at least one of a television broadcasting program and a data broadcasting program, at least one of the time information and a time code for specifying the printing-ordered image in the moving images or a film serving as the image content and information for identifying a delivery origin delivering the image content via a computer network.

In accordance with a third aspect of the invention, there is provided an image ordering system comprising: an image ordering component for being used by a customer to order prints; an image content service system for including image data; an image processing component for generating image printing data from the image data; a plurality of image printing systems for printing the image printing data, which image printing systems are connected to a network; and an image order processing device, the image order processing device including a reception and received order processing component for receiving image printing order information which is sent when the customer orders prints from the image ordering component; an image data obtaining component for obtaining, based on the image printing order information, image data of an image that is ordered to be printed from the image content service system; and a send processing component for selecting an optimal image printing system from the plurality of image and sending at least one of image data obtained by the image data obtaining component and the image printing data generated by the image processing component to the optimal image print system together with received order processing information which represents the contents of a received printing order, wherein the image ordering component, the image content service system, the image processing component, the image printing systems and the image order processing device are connected to the network.

As described above, in accordance with the first aspect, when a customer makes a printing order, the image printing order information sent from the image ordering component is received. The image data of the printing-ordered image is obtained from the image content service system. Then, the obtained image data or the image printing data generated from the obtained image data and the received order processing in-formation which indicates the contents of the printing order are sent to the optimal image printing system, which was selected from among the plurality of image printing systems. Thus, the invention has an excellent effect of being able to simply realize the environment in which printing orders for image content can be easily made.

In accordance with the first aspect, at least one of fee informing processing for informing a customer of a fee for the printing order via the image ordering component and a settlement processing for settling a fee for the printing order may be performed. Thus, in addition to the above-described effect, the invention has an effect ob being able to further simplify equipment to be added to each of the image printing systems.

In accordance with the first aspect, the customer information included in the received image printing order information may be stored in the customer information storage component. Thus, in addition to the above-described effects, the invention has an effect that customer management can be performed based on the stored customer information.

In accordance with the first aspect, the processing for managing the copyright of the printing-ordered image may be performed. Thus, in addition to the above-described effects, the invention has the effect of being able to further simplify the equipment to be added to each of the image printing systems.

In accordance with the first aspect, the processing for a customer to re-confirm the printing-ordered image may be performed by obtaining the original image data of the printing-ordered image and the thumbnail image data thereof and sending the thumbnail image data to the image ordering component. Thus, in addition to the above-described effects, the invention has an effect of being able to reduce the possibility that a customer incorrectly orders the image to be printed.

In accordance with the first aspect, based on the information for specifying the printing-ordered image, the image content service system that stores the data of the ordered image may be selected from among the plurality of image content serve systems connected to the network and the printing-ordered image may be specified. Thus, in addition to the above-described effects, the invention has an effect of being able to easily obtain the printing-ordered image even in the environment wherein printing orders for images of image content might be made from customers.

In accordance with the first aspect, the image data obtained by the image data obtaining component may be stored in the image data storage component. Thus, in addition to the above-described effects, the invention has an effect of being able to reduce an amount of communication to the image content service system.

In accordance with the first aspect, the image data subjected to at least one of compression and encryption may be obtained and at least one of decompression of obtained compressed image data and decoding of obtained encrypted image data may be performed. Thus, in addition to the above-described effects, the invention has an effect of being able to reduced an amount of communication to the image content service system.

In accordance with the first aspect, at least one of resolution conversion and image processing for image quality enhancement upon the obtained image data obtained may be performed so as to generate the image printing data. Thus, in addition to the above-described effects, the invention has an effect of being able to further simplify the equipment to be added to each of the image printing systems.

In accordance with the first aspect, at least one of editing of the obtained image data and synthesis of the same may be performed depending on the contents of the received printing order so as to generate the image printing data. Thus, in addition to the above-described effects, the invention has an effect of being able to further simplify the equipment to be added to each of the image printing systems.

In accordance with the first aspect, at least one of decompression of the image data to be sent to the optimal image printing system and decoding of the same may be performed. Thus, in addition to the above-described effects, the invention has an effect of being able to achieve at least one of reduction in an amount of communication to the image printing system and protect of the copyright of the sent image data.

In accordance with the second aspect, a plurality of image content service systems and a plurality image printing systems are each connected via a network to the image order processing device. All printing orders made by customers watching the image content via the image ordering components are collected in the image order processing device. In the image order processing device, the image content service system is selected and the printing-ordered image is specified, so that the image data of the printing-ordered image is obtained. Further, the optimal image printing system is selected, and the image data and the received order processing information are sent to the optimal image printing system. Thus, the image print finishing operator possessing the optimal image printing system prints the image. Thus, the invention has an excellent effect of being able to simply realize the environment in which printing orders for unspecified image content can be easily made.

In accordance with the second aspect, the image printing system possessed by a specified image print finishing operator designated by a customer or the image printing system possessed by the image print finishing operator nearest to the customer may be selected as the optimal image printing system. Thus, in addition to the above-described effect, the invention has an effect of being able to select the image printing system, which is optimal for a customer with high precision.

### BRIEF DESCRIPTION OF THE DRAWINGS

FIG. 1 is a block diagram showing an embodiment of schematic structure of an image delivery/order processing system relating to the present invention.

FIG. 2A is a block diagram showing an embodiment of a schematic structure of a card type scene marker.

FIG. 2B is a block diagram of an embodiment of a schematic structure of a scene marker which is built in a portable telephone.

FIG. 3 is a sequence view showing an embodiment of a print ordering sequence for image content displayed on a display component with a writing component.

FIG. 4 is a sequence view showing another embodiment of a print ordering sequence for the image content displayed on the display component with the writing component.

FIG. 5 is a sequence of an embodiment of a print sequence ordering for image content displayed on a display component with a receiving machine or a portable telephone which can function as the receiving machine.

FIGS. 6A through 6C are flowcharts showing the contents of an image order receiving and delivering processing carried out in an image order processing device.

### DESCRIPTION OF THE PREFERRED EMBODIMENTS

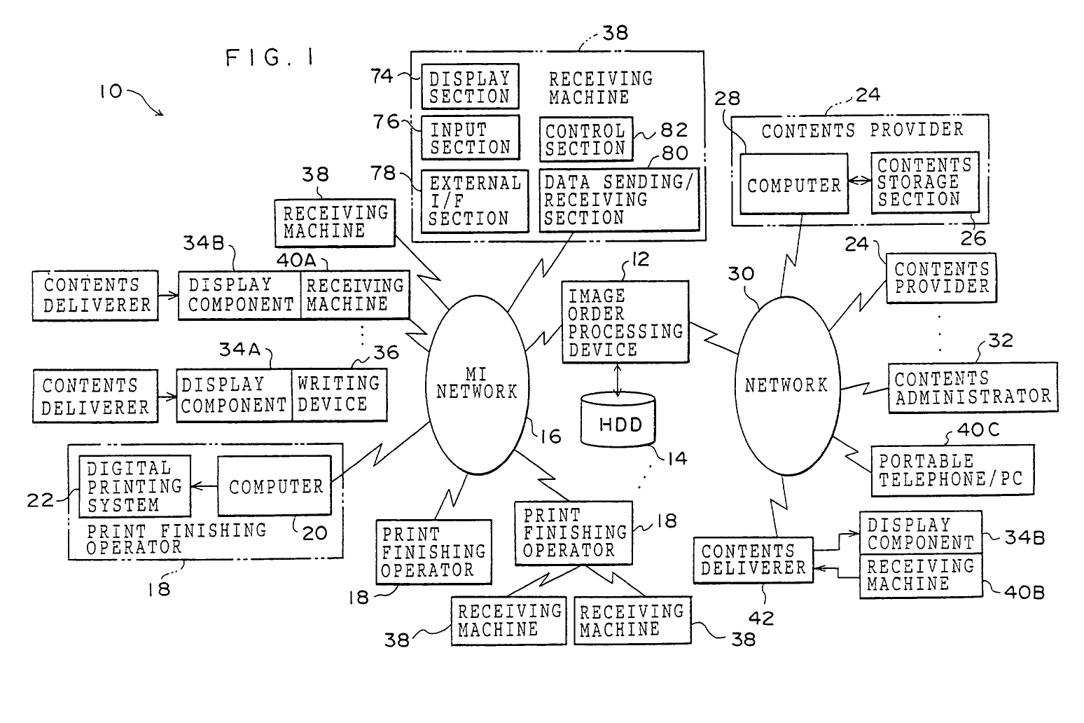

Hereinafter, embodiments of the present invention will be described in detail with reference to the drawings. FIG. 1 shows an image delivery/order processing system 10 relating to the present embodiment. In the image delivery/order processing system 10, various types of image content are delivered via various delivery components to a user, and an environment in which the user can order a printing of the desired image content is realized. Among the image delivery/order processing 10, a description will be given first of a section for processing printing orders from the user (i.e., a printing order processing system) hereinafter.

[Print Order Processing System]

The image delivery/order processing system 10 includes an image order processing device 12 which is installed at a large-scale photo lab (a so-called large lab) or the like in main cities all over the country. The image order processing device 12 is formed by a computer such as a workstation or the like. In the image order processing device 12, although not illustrated, CPU, ROM, RAM and input/output ports are connected to each other via buses, and various input/output devices including a display such as a CRT, an LCD or the like, a mouse, a keyboard, a hard disk device (HDD) 14 (see FIG. 1), a CD-ROM drive and a communication control device (e.g., a modem or a router) are connected to the input/output ports. In the image order processing device 12, an image order receiving and delivering program for the CPU of the image order processing device 12 to carry out an image order receiving and delivering processing relating to the invention (which will be described later) is installed in advance in the HDD 14. Because the CPU performs the image order receiving and delivering program, a computer that serves as the image order processing device 12 functions as an image order receiving device of the invention.

(A communication control device of) the image order processing device 12 is connected to an MI network 16, which comprises a high-speed and large capacity dedicated communication line. Computers 20 (e.g., personal computers (PCs)) possessed by print finishing operators 18 all over the country are connected to the MI network 16. Instead of the MI network, a computer network such as the Internet or the like may be employed.

The print finishing operator 18 has a digital printing system 22 which comprises a film scanner for reading images recorded in a photographic film and a digital printer for performing a print finishing processing so that an image represented by image data is recorded in recording material such as a photographic printing paper or the like. The digital printing system 22 is connected to the computer 20, and can perform the print finishing processing using the image data received by the computer 20 via the MI network.

[Image Contents Delivery]

Next, delivery of image content to a user will be described. In the present embodiment, examples of content provider for providing image content include providers who specialize in providing of contents, such as producers who make programs (moving or still images (the still images can be delivered by using data broadcasting in BS broadcasting)) that are broadcasted by digital broadcasting, film distributing companies which distribute films shown at digital theaters, image producers who produce live images that are delivered by Internet live performance sites. In addition to these providers, examples of the provider further include professional photographers, amateur photographers, astronomical observatories that take space photographs, companies that take aerial photographs and owners of unmanned fixed cameras. Further, any person may be a content provider by using “Personal Casting TV”, i.e., a personal casting service that has recently started.

Examples of the image content provided by the aforementioned content providers include various types of image content such as various moving or still images broadcasted by the digital broadcasting, films shown at digital theaters, various live images delivered from Internet live performance sites, various types of photographs shot by professional photographers or amateur photographers (e.g., photographs of scenes by which people move such as fine performance scenes in sports, photographs of live shows, photographs of art museums or museums, scoop photographs), photographs of various local scenes (e.g., an athletic competition, a concert, a school picnic, a class scene, a graduation ceremony, an entrance ceremony, a coming-of-age ceremony and a festival) shot by local photographers, space photographs shot by the space observatories, aerial photographs shot by the companies that take aerial photographs, fixed point observation photographs shot by the unmanned fixed cameras and souvenir photographs shot at fixed points in famous tourist locations. In addition to the aforementioned image content, examples of the image content may include images of video games and images (e.g., X-ray photographs) for medical use.

These image content are delivered as follows. Namely, a program made by a producer (moving or still image) is brought to a digital broadcasting station (a content deliverer) and delivered (broadcasted) by the broadcasting station. The image content broadcasted by the broadcasting station are provided to a user by being displayed on a display (i.e., display component) of electronic equipment (e.g., a TV or a PC), which includes a function of receiving digital broadcasting. A film distributed by a film distributing company is brought in a digital theater (the content deliverer) and delivered (shown) by projecting equipment in the digital theater to be shown to a user. In this aspect, the projecting equipment corresponds to the display component.

A live image, which is made by a producer and is to be delivered at an Internet live performance site is transmitted to an administrator (content deliverer) on the Internet web site and delivered on the Internet by the administrator. The live image delivered by the administrator of the Internet web site is provided by a user accessing the live site via an electronic equipment (a PC, a portable telephone or a portable information equipment), which includes a function of connecting to the Internet, and displaying the live image on the display (the display component) of the electronic equipment.

Examples of the delivery component for delivering image content other than the aforementioned image content include an electronic signboard and the Internet. The electronic signboard comprises a display and a communication control section, which is connected to a communication line and receives data of images to be displayed on the display. The electronic signboard is placed at places where many people go by or equipment that a user may encounter impressive scenes (e.g., a stadium, a theater, an art museum and a museum). The image content provided from a content provider to an administrator of electronic signboard is delivered by being displayed on the electronic signboard (display component) by the administrator of the electronic signboard (content deliverer), and provided to users passing by places where the electronic signboards are installed.

Delivery of image content using the Internet, which serves as the delivery component is performed by a content provider bringing (e.g., on-line transferring) the image content to an administrator (content deliverer) of a web site (one example being the aforementioned Internet live performance site) which delivers the image content, or by the content provider disclosing (delivering) the image content on the web site administrated by the content provider himself (in the latter case, the content provider himself becomes the content deliverer). In this aspect, providing the image content to the user is performed by the user accessing via an electronic equipment (a PC, a portable telephone or a portable information equipment) having a function of connecting to the Internet to the web site which delivers the image content so as to display the image content delivered by the web site to which the user is accessing on a display of the electronic equipment (display component).

[Management of Image Contents]

The image content delivered by the content deliverer to the user are managed (stored) in the image delivery/order processing system 10 so as to respond to a printing order from the user. Namely, as shown by a reference numeral “24” in FIG. 1, the content provider has a contents storing section 26 which is formed by a storage component such as an HDD, or the like, and in which image data (data of image with high quality and high resolution, data of thumbnail image with low resolution and usage fee information), which is includes in the image content provided to the content provider, are stored. The usage fee information represents a fee for using the high image quality image data in order to produce photographic prints. The usage fee for an image is paid to the content provider who is a copyright holder. When the image includes a predetermined person as a subject, a portion of the usage fee might be paid to the subject as a fee for the right of image.

The contents storing section 26 is connected to a computer 28, and the computer 28 is connected to a network 30. The image order processing device 12 is also connected to the network 30. The computer 28 can communicate with the image order processing device 12 via the network 30.

The network 30 may comprise one or more of the following: a public telephone line network; a dedicated communication line network; a portable telephone network in which a large number of switching machines are connected together via a communication line and a large number of base stations, which are placed at different locations and govern wireless communication to portable telephones, are respectively connected to the switching machines; a computer network (e.g., the Internet) in which a large number of web servers, formed by a work station or the like, are connected together via a communication line. Alternatively, the network 30 may include all or a portion of the aforementioned networks.

The image content delivered to a user is not limited to being managed (or stored) by the content provider. A contents administrator (indicated by a reference numeral “32” in FIG. 1) who has been commissioned by the content provider may manage the image content. Of course, the image content may also be managed by the content deliverer.

[Method for User to Order Print]

There are several methods by which a user orders image printing of desired image content in the image delivery/order processing system 10. A typical ordering method is an ordering method (a first ordering method) utilizing a writing device, which is built in or provided at the display component, a scene marker processed by a user and a receiving machine. In the first ordering method, the image ordering component relating to the invention comprises the writing device, the scene marker and the receiving machine. First, a description will be given of the scene marker.

The scene marker is a tool for the writing device to write information (image specifying information) for specifying images (printing-ordered images) in response to a user's designation when there are images among various types of image content delivered to the user, that the user would like to save by storing them as photographic prints. When the user orders prints via the receiving machine (which will be described later), the image specifying information written in the scene marker possessed by the user is read out by the receiving machine and transmitted to the image order processing device 12. Thus, when print ordering, the printing-ordered images can be identified by the image order processing device 12 without requiring the user to perform a complicated operation such as an oral transmission of the printing-ordered images.

The scene marker is preferably a card type that is easily held and carried by the user. The simplest configuration of the scene marker is a magnetic card. However, an existing magnetic card has drawbacks in that it has limited storable amount of information (data of only 72 characters), it is easily forged and a malicious third party can illegally read out data from it with ease.

For this reason, if consideration is given to other information (e.g., the user's personal information that the user must transmit at a time of printing ordering), being written into the scene marker in addition to the image specifying information, the scene marker is preferably an IC card. The existing IC card has a large-capacity storage component which is capable of storing a few thousands characters and has a CPU disposed therein. Further, a program can be built in the IC card. Thus, it is possible to prevent illegal reading of data by the malicious third party by securely setting a key for invoking the information stored in the chip. Moreover, forgery is essentially impossible, and the IC card is preferable as a scene marker.

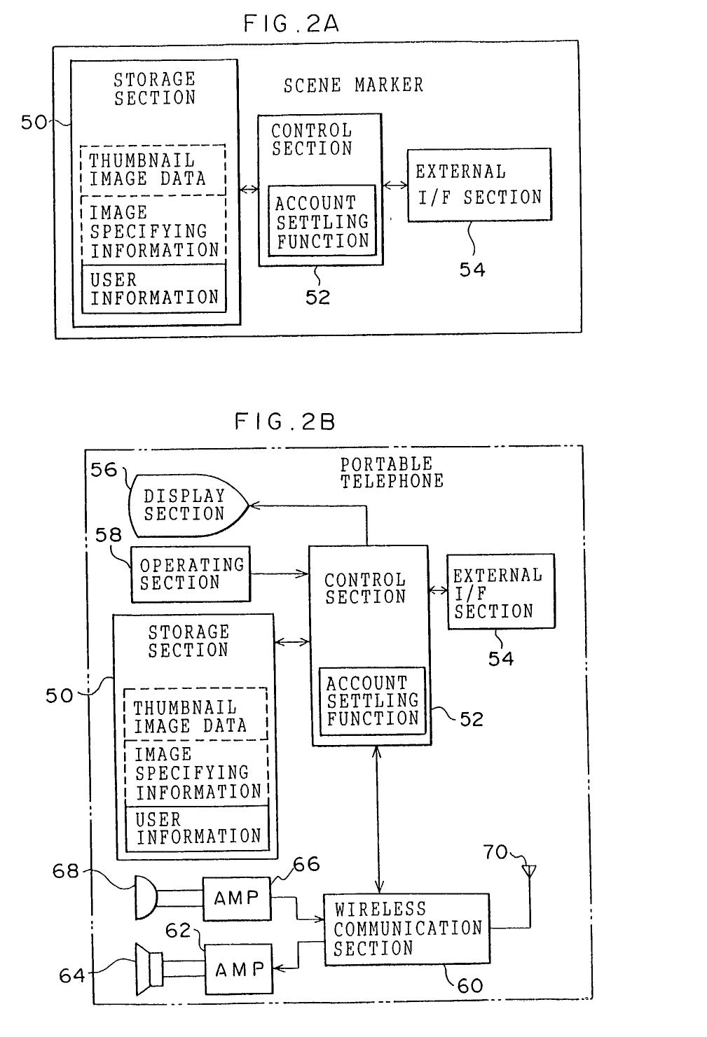

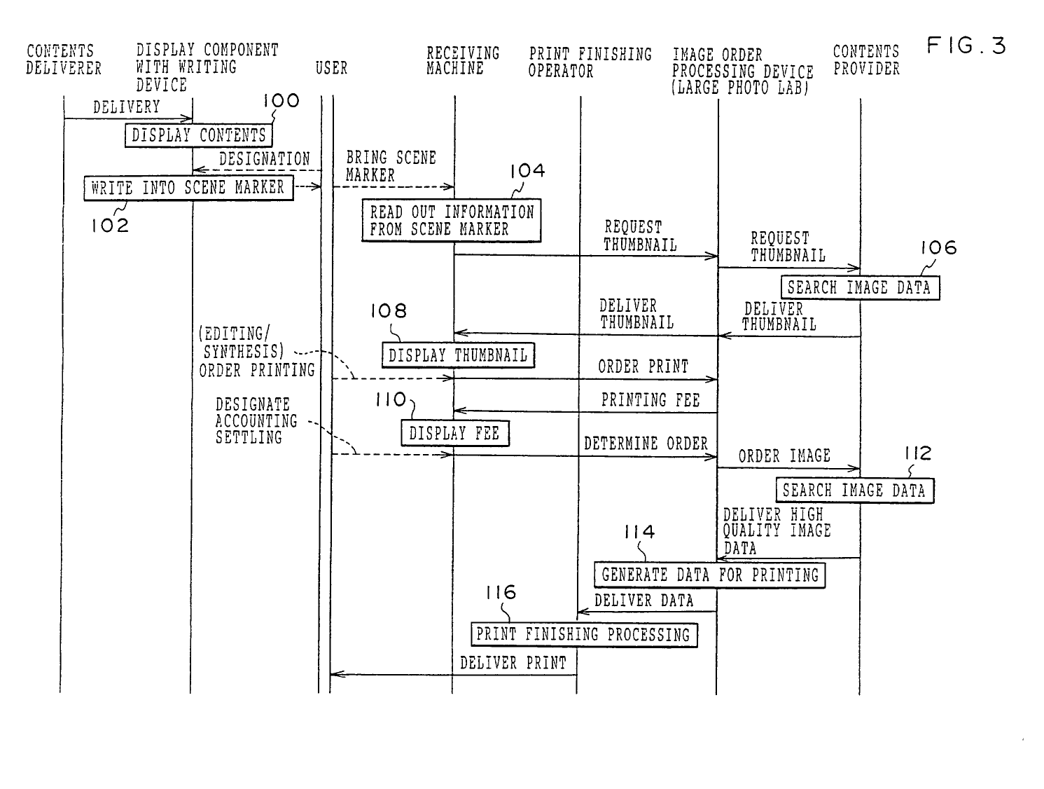

FIG. 2A shows an example of structure of a card type scene marker formed by an IC card. This scene marker comprises a storage section 50 which can store any information including the image specifying information, a control section 52 including a CPU or the like and an external I/F section 54 for sending and receiving the information to and from outside.

An interface between the IC card and the outside is roughly classified into a contact type interface and a contactless type interface. The contactless type interface is further classified into a close coupled type with the maximum communication distance of around 2 mm, a vicinity type with the maximum communication distance of around 10 cm, a proximity type with the maximum communication distance of around 70 cm and a microwave type with the maximum communication distance of a few meters (which is capable of communicating even if the user having it is moving and which can utilize a standard such as Bluetooth or HomeRF). Any of the aforementioned types may be used for the external I/F of the IC card for scene marker. However, if the contactless type having a relatively long communication distance is utilized, a user need not to take out the card type scene marker and set it to a predetermined position of the receiving machine when print ordering, which is preferable.

Personal information about the user possessing the scene marker (user information) is stored in the storage section 50. The user information may be configured to include at least one of a user ID, which identifies each of the users, user name, user address, user contact information (any one of a user telephone number, a user facsimile number, user electronic mail address may be used). The user information stored in the storage section 50 is read out therefrom by the receiving machine and sent to the image order processing device 12 when a user orders prints with the receiving machine.

As shown in FIG. 2A, the control section 52 preferably has a settlement function. A settlement method may be a prepaid method or a credit method. For this reason, settlement can be also completed by the receiving machine when a user orders prints. Personal identification and settlement may be performed by a service provided by a trusted third party.

The scene marker is not limited to the card types, and the function of the scene marker may be built in a portable telephone. Alternatively, portable information equipment such as a PDA (Personal Digital Assistants), a wearable computer (a computer which is operable while being carried by a user), a portable computer and a portable telephone having a function of connecting to a computer network such as the Internet can function as the scene marker. FIG. 2B shows an example of structure of scene marker, which is built in portable telephone.

The scene marker includes the above-described storage section 50, the control section 52 and the external I/F section 54. Connected to the control section 52 are a display section 56 which is formed by an LCD and can display various information including an image, an operating section 58, which includes an electric power and a ten key and a wireless communication section 60. A speaker 64 is connected to the wireless communication section 60 via an amplifier 62. A microphone 68 is also connected to the wireless communication section 60 via an amplifier 66. Further, an antenna 70 is also connected to the wireless communication section 60. The wireless communication section 60 has a function of wireless communicating, under the control of the control section 52, via the antenna 70, to a base station connected to a public telephone line by an electromagnetic wave within a frequency band which is predetermined for portable telephones. Currently, the portable telephone is widely used. Thus, by incorporating the function of the scene marker into the portable telephone, as compared to a user carrying the scene marker itself, it is possible to prevent a user from feeling inconvenienced by having to carry the scene marker.

The scene marker may be spread by being distributed to users for free by persons concerned, for example a content provider, an operator at a large lab and a print finishing operator. In the aspect in which the portable telephone or the portable information equipment functions as the scene marker, the scene marker may be spread by distributing a program which enables the portable telephone or the portable information equipment to operate as the scene marker for free (by distributing a recording medium with the program recorded therein for free or by permitting downloading of the program for free).

Next, the writing device will be described. Writing the image specifying information into the scene marker is performed by a writing device 36 which is built in or provided at the display component 34A as shown in FIG. 1. Any display component, which displays image content (e.g., a television, a PC, a portable telephone, portable information equipment, an electronic signboard, a screening equipment at a digital theater or the like) can be applied as the display component 34A. For example, if the display component 34 is the screening equipment at the digital theater, the writing device 36 can be mounted to a seat in which the user sits.

The typical writing device 36 is formed by an input portion for a user to input the information, an obtaining section for obtaining the image specifying information, an I/F section for sending and receiving the information to and from the scene marker and a control section which controls operations of the respective sections. When a user designates an image to be printed via the input portion, the obtaining section obtains the image specifying information corresponding to the designated printing-ordered image. Then, the obtained image specifying information is written, via the I/F section into the storage section 50 of the scene marker possessed by the user (see FIGS. 2A and 2B).

When the interface of the scene marker to outside is the contact type or a contactless type with a relatively short communication distance, the I/F section of the writing device 36 may include a loading section for loading the scene marker into a predetermined position. When the interface of the scene marker to outside is a contactless type with a relatively long communication distance, the I/F section of the writing device 36 may be formed by the wirelessly communication section which wireless communicates with the scene marker. When the scene marker is built in a portable telephone, the operating section 58 of the portable telephone may take place of the input section. If a part of the image specifying information to be written into the scene marker is fixed information, a storage section for storing the fixed information may be provided.

The contents of the image specifying information are different depending on the type of the delivery component, which delivers the image content. For example, an image of the image content that was displayed on an electronic signboard may be specified by information including an electronic signboard ID used for specifying the electronic signboard which displayed the image, a date when the image was displayed on the electronic signboard and a display position indicating where on a display surface of the electronic signboard the image was displayed. When a user designates an image to be printed via the input section (e.g., designates the display position of the image), the writing device 36 which is built in or provided at the electronic signboard obtains the aforementioned information as the image specifying information corresponding to the printing-ordered image (e.g., the electronic signboard ID can be obtained by first being fixedly stored in the storage section and then being read out from the storage section, and the date information can be obtained from an internal calendar or an internal clock). The obtained information is written into the storage section 50 of the scene marker possessed by the user.

Instead of the date information or the display position information, an image ID that is attached in advance to each image may be used. The image ID can be obtained by inquiring of the electronic signboard. In the above-described aspect, the input section of the writing device 36 may be substituted for by various keys provided at a remote controller of television.

The image which is displayed on the display component 34A of a television or a PC by receiving a digital broadcast can be specified by information including a broadcast program ID for specifying the corresponding broadcast program, a time when the corresponding image is displayed and a frame ID attached to the corresponding image. When the user designates the image to be printed by the input section (e.g., when the user would like to order the image displayed on the component 34A to be printed, the user designates the image by pressing, like a shutter of camera, a predetermined key of the input section), the writing device 36 which is built in or provided at the display component 34A for displaying the digital broadcasting obtains the aforementioned information as the image specifying information corresponding to the printing-ordered image (the broadcast program ID can be obtained from a receiver built in the display component 34A (the frame ID can be obtained by the same manner; see JP-A No. 10-171027), and the time information can be obtained from the internal clock), and the obtained information is written into the storage section 50 of the scene marker possessed by the user.

Recently a system has been considered in which a home server having a large-capacity storage medium is installed at a home of a digital broadcasting viewer. Digital broadcasting data received by the home server during a fixed period, e.g., a week, is stored and stored in the home server such that the viewer can playback and view the digital broadcasting at a desired time using the stored data. If this technology is utilized, there may be a time lag between the time when the user who is the digital broadcasting viewer finds an image, among moving images of the digital broadcasting the user is watching, which the user would like to store as a photographic print and the time when the user performs printing order operation. However, even when there is a time lag by using the data stored and stored in the home server, the image that the user would like to store as a photographic print and images before and after this image, can be displayed again on the display component 34A of a television or a PC. Thus, the image specifying information can be obtained without the above-described time lag.

The image which is displayed on the display component 34A (screen) by a film being shown at a digital theater can be specified by information including a film ID for identifying the film being played (alternatively, a movie theater ID for specifying the movie theater which plays the film or a hall ID for specifying a hall which plays the film), a date of watching the film, a time when the corresponding image is displayed and a frame ID which is-attached to the corresponding image. When a user designates the image to be printed via the input section (e.g., when the user would like to order the displayed image to be printed and designates the image by pressing a predetermined key of the input section), the writing device 36 which is provided at the display component 34A which plays the film (displays the image) obtains the aforementioned information as the image specifying information corresponding to the printing-ordered image (the film ID can be obtained from a screening equipment installed at the digital theater (by the same manner as the frame ID) and the time information can be obtained from the internal clock), and the obtained information is written into the storage section 50 of the scene marker that the user has.

The image which is displayed on a display of electronic equipment (the display component 34A) by a user accessing via the electronic equipment, which has a function of connecting to an Internet (e.g., a PC, a portable telephone or a portable information equipment) to a web site which delivers the image content (including an Internet live performance site) can be identified by information such as a URL (Uniform Resource Locator) of the web site. When the corresponding image is a frame image of moving images, the image can be identified by the information such as a time when the corresponding image is displayed or a frame ID that is attached to the corresponding image. When the corresponding image is one of multiple images disclosed on the web site, the image can be identified by the ID of the corresponding image.

When a user designates the image to be printed via the input section, the writing device 36 which is built in or provided at the electronic equipment obtains the aforementioned information as the image specifying information corresponding to the printing-ordered image (the URL can be obtained from the electronic equipment, the time information can be obtained from the internal clock and the frame ID or the image ID can be obtained from the web site via the electronic equipment), and the obtained information is written into the storage section 50 of the scene marker possessed by the user has.

The obtaining component of the writing device 36 may obtain, in addition to the image specifying information, low resolution image data (thumbnail image data) of the printing-ordered image. The I/F section of the writing device 36 may write the thumbnail image data into the storage section 50 of the scene marker (see FIGS. 2A and 2B).

Next, the receiving machine will be described. As shown in FIG. 1, the receiving machine 38 is connected to the MI network 16. (The receiving machine 38 may be directly connected to the MI network or may be connected to the MI network 16 via the computer 20 of the print finishing operator; see FIG. 1.) The receiving machine 38 is installed anywhere, such as a convenience store, a shopping mall, a theme park or the like. The receiving machine 38 includes a display section 74 which is formed by a CRT or an LCD and can display images, an input section 76 for a user to input various types of information, an external I/F section 78 which can send and receive the information to and from an image data recording medium such as a scene marker or a digital still camera (DSC), a data sending and receiving section 80 which can send and receive the data via the MI network 16 to and from the image order processing device 12 and a control section 82 which controls operations of the various sections of the receiving machine 38.

In the first ordering method, if there is an image, among the various types of the image contents delivered to the user, that the user would like to store by storing it as a photographic print the user writes the image specifying information (and the thumbnail image data) into a scene marker possessed by the user using the writing device 36 which is built into or provided at the display component 34A which is displaying the image (the printing-ordered image). Then, the user goes to a place where the receiving machine 38 is installed with the scene marker into which the information is written. The user orders, via the receiving machine 38, the image (i.e., the image whose image specifying information is written into the scene marker) to be printed by the receiving machine 38. Thus, the information, such as the image specifying information or the user information, is read out from the scene marker by the external I/F section 78 of the receiving machine 38, and the read out information is sent to the image order processing device 12 by the data sending and receiving section 80.

In the first ordering method, editing of the image (e.g., trimming of the image) or synthesis with another image (e.g., a template for making a New Year's card or a calendar) can be performed. The input section 76 of the receiving machine 38 is configured such that a user can designate the editing or the synthesis of the image.

As shown in FIG. 1, a receiving machine 40 which is built into or provided at a display component 34B is also among the receiving machines (see a receiving machine 40A shown in FIG. 1). An ordering method utilizing the receiving machine 40 (i.e., a second ordering method) will be described hereinafter. In a typical example of the second ordering method, the image ordering component relating to the invention comprises a scene marker and a receiving machine like the above-described receiving machine 38, the typical receiving machine 40 includes, the display section, the input section, the external I/F section and the data sending and receiving section which can send and receive the data to and from the image order processing device 12. Further, the receiving machine 40 includes an obtaining section, which obtains, as the writing component 36, the image specifying information corresponding to the type of the delivery component.

In the second ordering method, if there is an image among the various types of the image contents delivered to the user, that the user would like to keep by storing it as a photographic print, the user designates the image to be printed by the input section of the receiving machine 40 which is built into or provided at the display component 34B which is displaying the corresponding image (i.e., the printing-ordered image). Thus, the obtaining section of the receiving machine 40 obtains the image specifying information, and the image specifying information obtained by the obtaining section is sent to the image order processing device 12 by the data sending and receiving section without being written into the scene marker.

The second ordering method is not suitable for the user to designate editing or synthesis of the image at a time of printing ordering. However, the second ordering method has an advantage that the user need not take the scene marker to the place where the receiving machine 38 is installed.

The user information may be obtained by the user inputting via the input section (in this case, the external I/F section can be omitted). However, the user information is preferably obtained by being read out from a storage medium possessed by the user (e.g., any one of a magnetic card, a scene marker, an IC card or a portable telephone having the same function as the scene marker, and portable information equipment).

The receiving machine 40 may be connected via the MI network 16 to the image order processing device 12 (see the receiving machine 40A shown in FIG. 1) or may be connected via the content deliverer 42 and the network 30 to the image order processing device 12 (see the receiving machine 40B shown in FIG. 1). Specifically, a digital broadcasting equipment is provided with an uplink function (i.e., a function of sending information from a receiver to a broadcasting station at a communication speed of 2,400 bps). The receiving machine 40B, which is built into or provided at the display component 34B, which receives and displays digital broadcasting, utilizes the uplink function so as to send the information such as the image specifying information to the image order processing device 12 via a broadcasting station, which serves as the content deliverer 42, and the network 30.

The receiving machine 40 may be built into electronic equipment for which a display section serving as the display component is provided. Examples of this electronic equipment includes a PC, a portable telephone and portable information equipment. For example, in FIG. 1, a portable telephone or a PC including the function of the receiving machine is indicated by a reference numeral “40C”. The function of the receiving machine can be imparted to the electronic equipment includes a built in CPU by installing a predetermined program, and the information such as the image specifying information can be sent via the network 30 to the image order processing device 12.

[Print Ordering Sequence (1) by First Ordering Method]

Next, an example of printing ordering sequence by the first ordering method will be described with reference to FIG. 3. As described above, in the present embodiment, various types of image content are delivered by various content deliverer to various deliver components (i.e., display components), and respectively displayed on the display components (see step 100 in FIG. 3 as an example).

The printing ordering by the first ordering method is performed when an image that a user would like to save by storing it as a photographic print is an image that is displayed on the display component 34A which is built into or provided at the writing device 36 or when the user would like to carry out a processing such as editing synthesis of the image to be printed. The user inputs, via the input section of the writing device 36, the information for designating the image to be printed. Thus, the writing device 36 writes the image specifying information into the scene marker possessed by the user (see step 102 in FIG. 3). In the sequence shown in FIG. 3, the thumbnail image data is not written into the scene marker.

When the image specifying information has been written into the scene marker, the user takes the scene marker, to a place where the receiving machine 38 is installed. Then, the user inputs the information for instructing the printing order of the image via the input section 76 of the receiving machine 38. The external I/F section 78 of the receiving machine 38 reads out the image specifying information and the user information from the storage section 50 of the scene marker possessed by the user (see step 104 in FIG. 3). The receiving machine 38 adds the read out image specifying information and user information and a receiving machine ID for specifying the receiving machine 38 to the information which indicates a request to send the thumbnail image data, and sends the resultant information via the data sending and receiving section 80 to the image order processing device 12. In this way, the receiving machine 38 requests the image order processing device 12 to send the thumbnail image data of the printing-ordered image which is specified by the image specifying information.

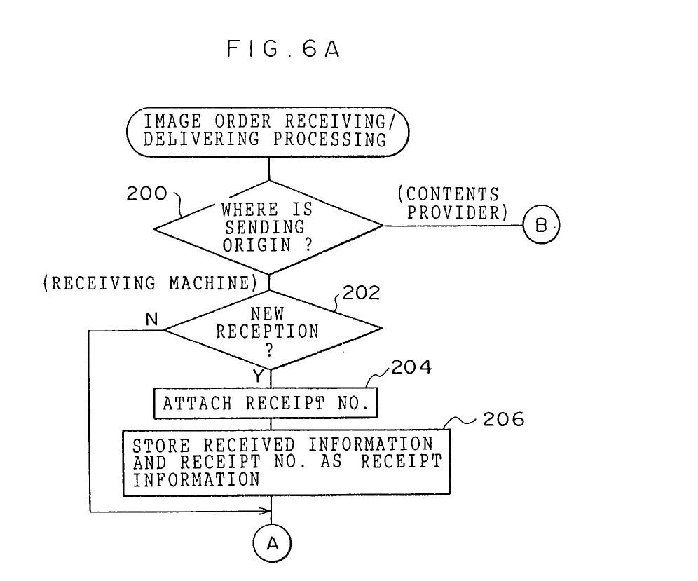

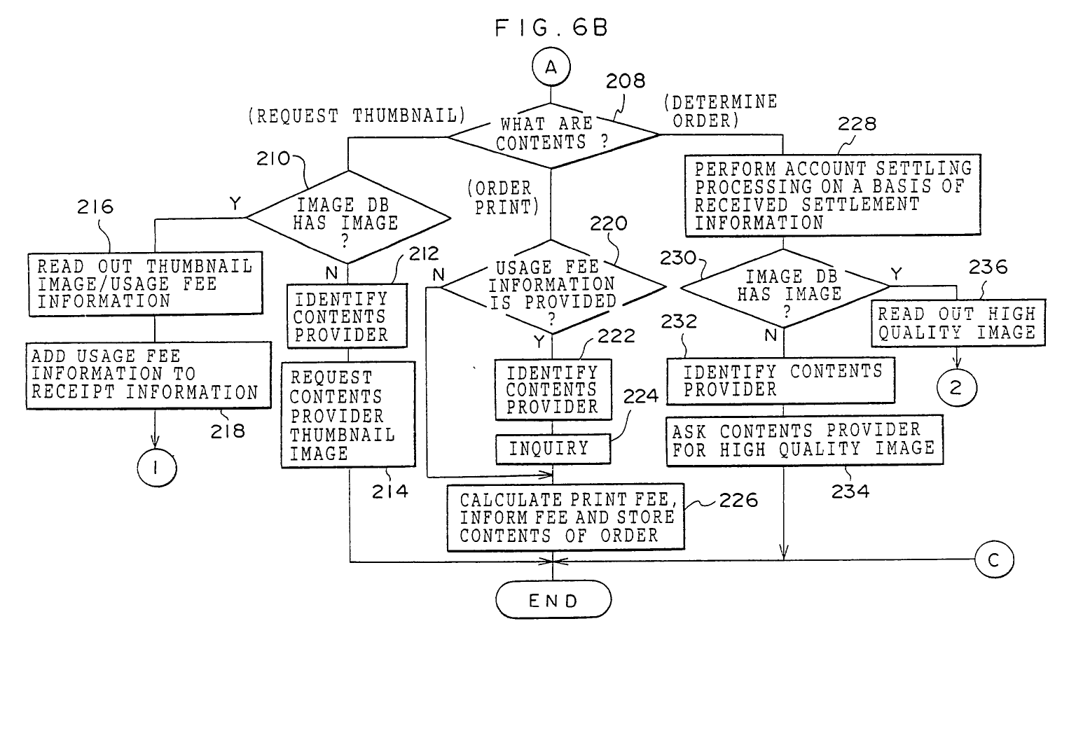

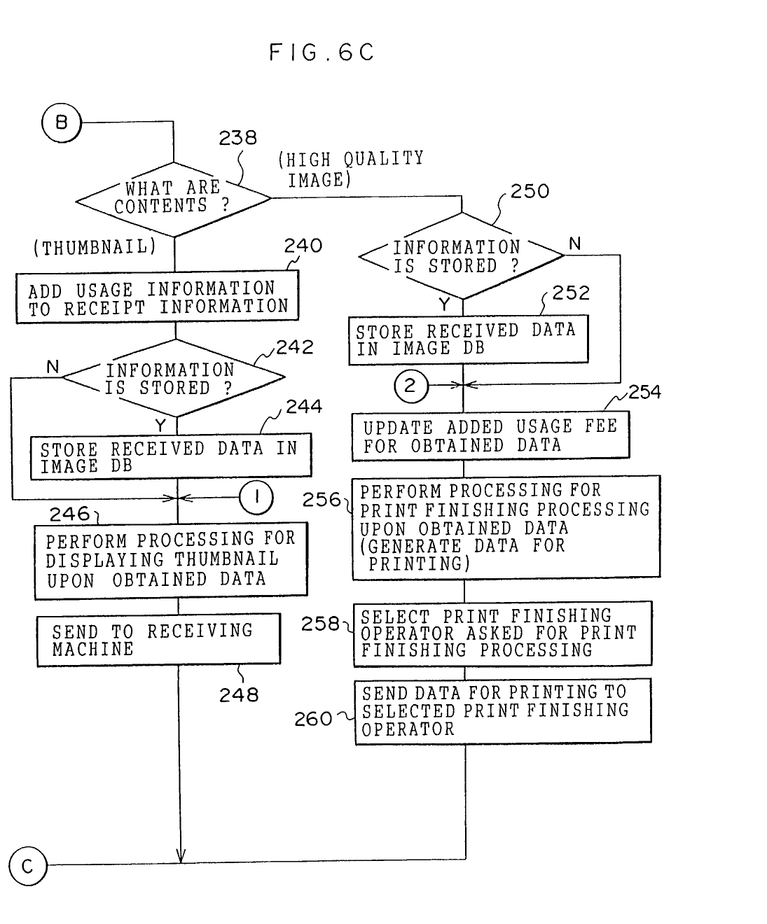

When the image order processing device 12 receives any information from outside, it carries out an image order receiving and delivering processing shown in FIGS. 6A through 6C. In the image order receiving and delivering processing, first, it is determined in step 200, whether a sending origin of the received information is a receiving machine or a content provider (or a contents administrator). When the sending end of the information is the receiving machine, a process proceeds to step 202, and it is determined, based on the contents of the received information, whether the received information is information corresponding to a new printing order.

Since the image order processing device 12 receives a large number of printing orders and processes the same in parallel, a receipt number for identifying each printing order is attached to each of the received printing orders. The receipt number of the printing order is attached to the information about the corresponding printing order with the receipt number attached thereto which information is sent and received between the image order processing device 12 and the receiving machine/the content provider.

For this reason, if a receipt number is not attached to the received information, the answer to the determination in step 202 is affirmative and the process proceeds to step 204. In step 204, a receipt number is attached to a new printing order corresponding to the received information. In step 206, the information received from the receiving machine 38 (i.e., the receiving machine ID, the image specifying information and the user information) is associated with a receipt number and stored as received information in a memory or the like. Thereafter, the process proceeds to step 208. If the answer to the determination in step 202 is negative, the process proceeds to step 208 without performing any processings.

In step 208, the contents of request or notice represented by the information received from the receiving machine is judged on a basis of the contents of the information received from the receiving machine. In step 208, if it is judged that the receiving machine requests sending of data of thumbnail image of the printing-ordered image, the process proceeds to step 210. In step 210, it is determined, on a basis of the image specifying information received from the receiving machine, whether or not the data of the thumbnail image of the printing-ordered image that is required to be sent by the receiving machine is stored in an image database (DB) provided in the HDD 14.

The image DB is a database, which is provided for storing the data of images, which are frequently ordered to be printed (the thumbnail image data and the high quality image data). If the data of the required thumbnail image is not stored in the image DB, the answer to the determination 210 is negative and the process proceeds to step 212. In step 212, the content provider (or administrator) that is storing the image data of the printing-ordered image is identified based on the image specifying information received from the receiving machine.

Identification of the content provider (or administrator) is carried out as follows. Image identifying information for identifying each of the images, the image data of which is being recorded by the content providers in the content storage section 26, is associated with an ID, which identifies each of the content providers (or administrators). A pre-recorded content provider/administrator database is established in the HDD 14. The received image specifying information is compared with the image identifying information, which is stored in the content provider/administrator database. Finally, the content provider/administrator who is storing the image data for the ordered image, which ordered image is represented by the received image specifying information, can be performed.

In next step 214, the image identifying information and the receipt number are attached to the information indicating a request to send the thumbnail image data. Then, the resultant information is sent via the network 30 to the computer 28 of the content provider (or administrator) identified in step 212. Thus, the content provider (or administrator) is asked to send the thumbnail image data of the printing-ordered image. Then, the image order receiving and delivering processing is temporarily ended. As described above, the contents of the image identifying information differs depending on the type of the delivery component that delivers the image content. Accordingly, the image identifying information received from the receiving machine may be sent after being converted into certain code information for enabling an easy image search by the content provider (or administrator).

The computer 28 of the content provider (or administrator), which receives the above-described information, searches the contents storage section 26 using the received image specifying information as a key, and reads out the thumbnail image data of the printing-ordered image and the usage fee information from the contents storage section 26 (see step 106 in FIG. 3). The thumbnail image data may be obtained by storing only the high quality image data in the contents storage section 26 and then reading out the high quality image data and reducing the resolution thereof. The computer 28 attaches the received receipt number to the read out thumbnail image data and the usage fee information, and sends the reception number, the read out thumbnail image data, and the usage fee information to the image order processing device 12 via the network 30.

If the image order processing device 12 receives any information, it carries out the image order receiving and delivering processing (FIGS. 6A through 6C). If the sending origin of the received information is the computer 28 of the content provider (or administrator), the process proceeds from the above-described step 200 to step 238 and branches the processing depending on the contents of the received information. If the information received from the computer 28 is the thumbnail image data, the process proceeds from step 238 to step 240. In step 240, the corresponding receipt information is searched using the receipt number attached to the received information being a key, and the usage fee information which is added to the received information is added to the corresponding receipt information and stored.

In step 242, it is determined whether or not the received thumbnail image data is recorded in the image DB. When the printing-ordered image is very frequently ordered to be printed, the answer to the determination in step 242 is affirmed and the process proceeds to step 244 and after the received thumbnail image and usage fee information are registered in the image database, the process proceeds to step 246. If the answer to the determination in step 242 is negative, the process proceeds to step 246 without carrying out any processing. Consequently, when the image whose thumbnail image data is already stored in the image DB is ordered to be printed, the information about the image need not to be requested from the content provider (or administrator) again.

In the above-described step 210, when the data of the thumbnail image of the printing-ordered image, a sending of which is requested by the receiving machine, is stored in the image DB, the answer to the determination in step 210 is affirmative and the process proceeds to step 216. In step 216, the thumbnail image data of the image (i.e., the printing-ordered image), a sending of which is required by the receiving machine, and the usage fee information is read out from the image DB. In step 218, the usage fee information read out from the image DB is added to and recorded in the receipt information, and then the process proceeds to step 246. Thus, a frequency of request for the content provider to send the information (i.e., the thumbnail image data or the high quality image data) can be effectively decreased.

In step 246, a processing for displaying the thumbnail image data obtained by receiving from the content provider (or administrator) or reading out from the image DB on the display section 74 of the receiving machine 38 as the thumbnail image is performed. An example of this processing is an image processing such as a color space conversion for displaying the thumbnail image with appropriate image quality on the display section 74. Alternatively, when the compressed thumbnail image data is sent from the content provider (or administrator), decompression of the received image may be carried out in order to reduce a time required for sending and receiving of the thumbnail image data. Further, when the encrypted thumbnail image data is sent, decoding of the received data (i.e., removing encryption) may also be performed in order to prevent leakage of the thumbnail image data to the third party.

In step 248, the receipt number is attached to the thumbnail image data subjected to the processing in step 246. A receiving machine to which the information will be sent is identified on a basis of the receiving machine ID that is stored as the receipt information, and the information is sent to the identified receiving machine 38. Then, the image order receiving and delivering process temporally stops.

The receiving machine 38 which receives the information including the thumbnail image data from the image order processing device 12 uses the received information to displays the thumbnail image on the display section 74 (see step 108 in FIG. 3). Then, a user who has inputted the information for instructing the printing order of the image via the input section 76 of the receiving machine 38 can confirm the image that the user is ordering to be printed by looking at the image displayed on the display section 74.

When the printing-ordered image is an image which is captured from moving images (e.g., a film clip) in accordance with a user's designation, there may be a time lag between the time when the user identifies, among the moving images that the user is watching, an image that the user would like to store as a photographic print to the time when the user performs the operation for ordering print. For this reason, moving images including the image identified by the image specifying information and images before and after the image may be displayed as thumbnail images, and the user may determine whether or not the timing for capturing the image is appropriate.

When the user confirms that the thumbnail image displayed on the display section 74 is the same as the image that the user orders to be printed, the user inputs the information, which indicates details of the contents of printing order (e.g., a print size or a number of prints) via the input section 76 of the receiving machine 38. When the user desires to edit or synthesize the image to be printed, the user also inputs the information for designating editing or synthesis of the image to be printed. The image data which is provided to the user by displaying an image, which can be synthesized with the printing-ordered image (e.g., a template for making a New Year's card or a calendar) on the display section 74, may be sent from the image order processing device 12 to the receiving machine 38 or may be stored in advance in the receiving machine 38.

When the contents of printing order which is desired by a user is determined by the user inputting various types of information via the input section 76, the receiving machine 38 attaches the information which indicates the contents of the determined printing order and the receipt number to the information which indicates that there is provided a printing order, and sends the resulting information to the image order processing device 12.

The image order processing device 12 carries out successively the steps 200, 202 and 208 in the image order receiving and delivering processing (FIGS. 6A through 6C), and then the process proceeds from step 208 to step 220. In step 220, it is determined whether or not the usage fee information of the printing-ordered image is provided. As the usage fee information is obtained together with the receipt of the thumbnail image data in the ordering sequence shown in FIG. 3, the answer to the determination in step 220 is negative and the process proceeds to step 226.

In step 226, a fee for making a photographic print is calculated based on the information, which indicates the contents of the printing order, which is received from the receiving machine 38. Then, by adding an image usage fee, which is represented by the usage information that is added to and recorded in the receipt information in the above-described step 240 or 218, to the fee for making photographic print, a print fee, which should be charged to a user, is calculated. The print fee is disclosed to the receiving machine 38 by sending the information, which indicates the calculated print fee to the receiving machine 38. Further, the information received from the receiving machine 38 is added to and recorded in the receipt information to store the printing order contents. Then, the image order receiving and delivering processing temporally stops.

The receiving machine 38, which has received the print fee, displays the print fee, which is represented by the received information, on the display section 74 (see step 110 in FIG. 3). Thus, a user can easily confirm the print fee. A user who has confirmed the print fee inputs information which orders settlement of the fees via the input section 76 to determines the printing order which is designated by the user. Then, the receiving machine 38 requires the control section 52 of the scene marker possessed by the user to send the settlement information (i.e., information required to settlement the fees), attaches the settlement information sent from the scene marker and the receipt number to the information which indicates that the printing order has been determined and sends the resultant information to the image order processing device 12.

The image order processing device 12, which has received the information, carries out successively the steps 200, 202 and 208 in the image order receiving and delivering processing (FIGS. 6A through 6C), and the process proceeds from step 208 to step 228. In step 228, a settlement of fees processing is performed based on the settlement of fees information, which is included in the information received from the receiving machine 38.

The settlement processing is carried out as follows. If the settlement method is a credit type, the information for identifying a user such as a credit card ID is sent from the receiving machine 38 as the settlement information. Then, the settlement information received from the receiving machine 38, the user information which is stored as the receipt information and the information such as a print fee for received order is sent to a computer (not shown) of settlement authorization which is connected via a communication line to the network 30 to request that the settlement authorization to perform the settlement processing. When the settlement authorization completes the settlement processing, the receiving machine 38 receives a report that the settlement processing has been completed.

When the settlement method is a prepaid type, the settlement processing is performed as follows. Firstly, usage rate information read out from a scene marker is sent from the receiving machine 38. Then, a usage rate corresponding to the print fee for received order is subtracted from the usage rate indicated by the usage rate information received from the receiving machine 38. The usage rate information, which represents the usage rate after subtraction, is sent to the receiving machine 38 and written into the scene marker.

When the settlement processing is completed, the process proceeds to step 230. In step 230, it is determined, based on the image specifying information of the printing-ordered image, which is stored as the receipt information, whether or not the high quality image data of the printing-ordered image is stored in the image DB. If the answer to the determination in step 230 is negative, the process proceeds to step 232. In step 232, similar to the above-described step 212, the content provider (administrator), which is storing the image data of the printing-ordered image, is identified based on the image specifying information stored as the receipt information.

In step 234, the image specifying information and the receipt number is attached to the information which represents a request for sending the high quality image data, and the resulting information is sent via the network 30, to the computer 28 of the content provider (or administrator) identified in step 232. Thus, the content provider (or administrator) is requested to send the high quality image data of the printing-ordered image. Then, the image order receiving and delivering processing temporally stops.

The computer 28 of the content provider (or administrator), which receives the information, searches the contents storage section 26 using the received image specifying information as a key. Then, the high quality image data of the printing-ordered image is read out from the contents storage section 26 (see step 112 in FIG. 3). The computer 28 attaches the receipt number to the read out high quality image data and sends the resulting data to the image order processing device 12 via the network 30.

Since the network 30 relating to the present embodiment has a lower degree of security than that of the MI network 16, in order to prevent leakage of the high quality image data to the third party other than the content provider (or administrator) or the image order processing device (i.e., a large lab), the high quality image data sent from the content provider (or administrator) is preferably the encrypted image data. Encryption of the image data may be performed after reading out the image data from the contents storage section 26. Alternatively, the image data may be encrypted in advance and stored in the contents storage section 26.

The image order processing device 12 which received the information successively carries out the steps 200 and 238 in the receiving and delivering processing in order (FIGS. 6A through 6C). If the information received from the computer 28 is the high quality image data, the process proceeds from step 238 to step 250. In step 250, it is determined whether or not the received high quality image data is recorded in the image DB. When the printing-ordered image is an image, which is highly frequently ordered to be printed, the answer to the determination in step 250 is affirmative, and the process proceeds to step 252. In step 252, the received high quality image data is recorded in the image DB, and the process proceeds to step 254. If the answer to the determination in step 250 is negative, the process proceeds to step 254 without performing any processing. Thus, when the image whose high quality image data is recorded in the image DB is ordered again, the information of the image need not to be requested to the content provider (or administrator).

In the above-described step 230, when the high quality image data of the printing-ordered image the sending of which is requested by the receiving machine, is stored in the image DB, the answer to the determination in step 230 is affirmative and the process proceeds to step 236. In step 236, the high quality image data of the printing-ordered image is read out from the image DB and then the process proceeds to step 256. Consequently, a frequency that the content provider (or administrator) is required to send the high quality image data can be effectively reduced.

In the present embodiment, an integrated value of image usage fees for each of the images ordered by a user which fee should be paid for the content provider or the like is stored in HDD 14. In the next step 254, a process that renews the integrated value corresponding to the usage fees is performed every time an image printing is used by this print ordering of high quality image data which data was obtained by being read out from the image DB 14 or received from the content provider (administrator). The integrated value is read out periodically (e.g., for every month) and added for each payee (e.g., a content provider or administrator, or a payee for a fee for the picture rights). Then, the integrated value is automatically transferred to an account, which is designated by the payee in advance. The integrated value of the image usage fee is cleared (i.e., is made zero) for each time the image usage fee is transferred.

In step 256, a processing for generating image data for printing (i.e., image data that enables a print finishing operator to easily carry out a print finishing processing) from the obtained high quality image data is performed (see step 114 in FIG. 3). Decoding (releasing of encryption) of the encrypted high quality image data which is received from the content provider (or administrator) is included as the processing for generating the image data for printing.

Encryption or decoding of the data is usually performed by using a “key”. In a common key system in which the same key is used both in encryption and decoding of the data, high speed encryption processing can be achieved. However, when the data encrypted by a sender is decoded by a receiver, the key the sender has must coincide the key the receiver has. Thus, there is a problem in that a security is decreased when the key is sent or received between the sender and the receiver.

In a public key system, a cryptographic key used for encryption is different from a decoding key used for decoding. The cryptographic key is made public and the decoding key is kept secret. A sender encrypts a send data by using a public key of a receiver. The receiver decodes the received data by using the secret key. Thus, the system has high security. For this reason, in the present embodiment, encryption or decoding of the high quality image data is performed by the public key system. An international version of PGP (Pretty Good Privacy) or S/MINE (Secure Multipurpose Internet Mail Extension) is a known encryption software using a public key system, and such softwares may be used.

The high quality image data has a large amount of data due to its high resolution and therefore, it is assumed that it will take a long time to send and receive the data. Thus, when sending the high quality image data from the content provider (or administrator) to the image order processing device 12, the send data is preferably compressed. In this case, in step 256, decompression (or decoding) of the compressed high quality image data received from the content provider (or administrator) is performed as one of processings for generating the image data for printing. Various types of known algorithms may be utilized for compression and decompression of the data.

A processing in accordance with the contents of the printing order from a user may be performed in step 256 as one of the processings for generating the image data for printing. Specifically, examples of such processing include resolution conversion (pixel density conversion) depending on a print size designated by a user, editing (e.g., trimming) of the image data in accordance with a designation from the user and synthesis of the image data (synthesis of the image data with a template).

Further, an image processing for image quality enhancement may be performed as one of the processings for generating the image data for printing in step 256. Specifically, examples of such image processing include a color/density correction including tone conversion or color conversion, a color space conversion for reproducing the printing-ordered image on a recording medium such as a printing paper or the like so as to have an appropriate color tint, a hypertone processing for compressing tone of extremely low frequency luminance component of the image, a hypersharpness processing for emphasizing a sharpness while suppressing granuarity, a defective portion correction processing for correcting defectives of the image due to defective pixels of photographing sensor and the like. Consequently, an image quality of the photographic print made by a print finishing operator can be enhanced.

By performing at least one of the above-described processings, equipment that should be installed to achieve an environment, wherein images of various image content can be ordered to be printed can be simplified. Further, the image delivery/order processing system 10 relating to the present embodiment can be easily constructed.

If it takes a long time to receive the image data for printing sent from the image order processing device 12 because a data communication speed between the image order processing device 12 and the computer 20 of a print finishing operator is slow, hindering a service of the print finishing operator, a processing for temporally compressing the generated image data may be performed as one of the processings for generating the image data for printing. Alternatively, when a communication line between the image order processing device 12 and the computer 20 of the print finishing operator has low security, a processing for temporally encrypting the generated image data may be performed.

In step 258, a print finishing operator who will ask to perform a print finishing processing is selected. Specifically, the print finishing operator closest to a user's address may be selected by referring to the user information, which is stored as one of the receipt information. Alternatively, when a user designates the print finishing operator via the input section 76 of the receiving machine 38, the designated print finishing operator may be selected. In step 260, the information, which represents the contents of printing order, and the user information are added to the image data for printing generated in step 256, and the resultant information is sent, via the MI network 16, to the print finishing operator selected in step 258.

The print finishing operator receives the image data for printing via the MI network 16 and the computer 20, and then performs a print finishing process, in accordance with the contents of the printing order represented by the received image data for printing, with the digital print system 22 (see step 116 in FIG. 3). Then, photographic prints made by the print finishing process are delivered to a user's home that can be identified by the received user information. Thus, the results of the printing order made by the user are delivered to the user.

[Print Ordering Sequence (2) by the First Ordering Method]

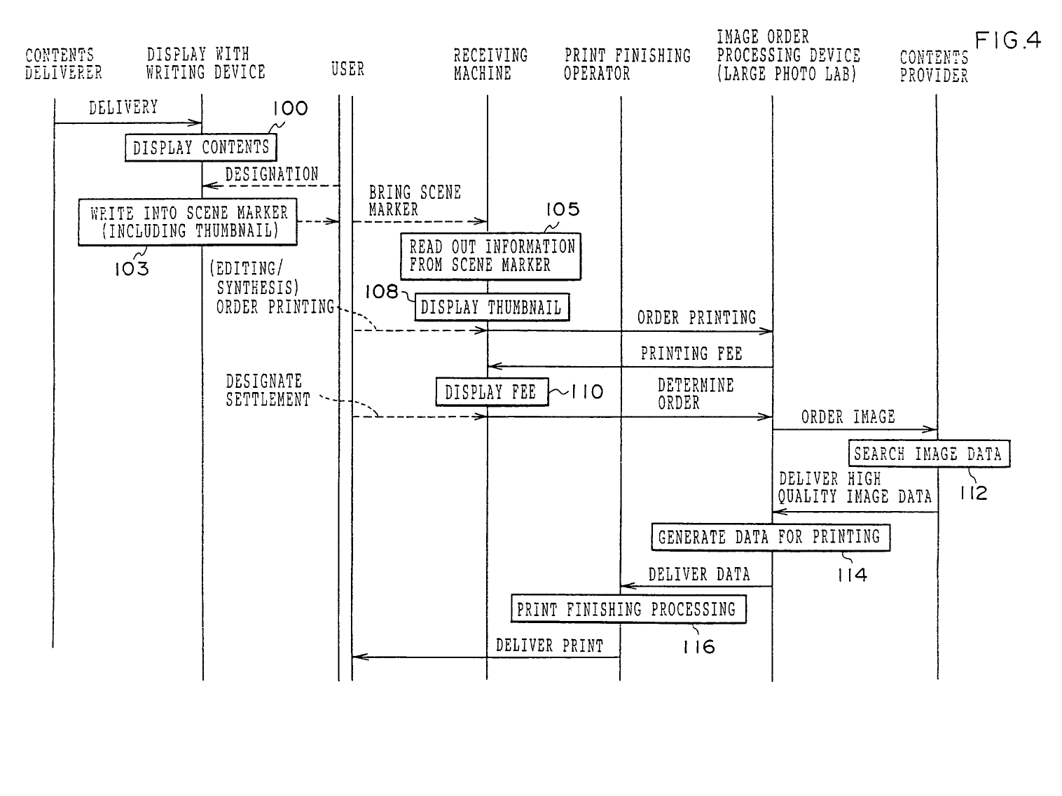

Next, another example of a printing ordering sequent by the first ordering method will be described with reference to FIG. 4. Here, only the portions that differ from the printing ordering sequence shown in FIG. 3 will be described.

In a printing ordering sequence shown in FIG. 4, when a user inputs information for designating an image to be printed via the input section of the writing device 36, the writing device 36 obtains the image specifying information and thumbnail image data of the printing-ordered image and writes this data into the scene marker (see step 103 in FIG. 4). The thumbnail image data can be obtained by the display component 34A, which is configured to store the image data for display for a fixed period of time. When the display component 34 is that the image to be printed is being designated from the writing device 36, the display component 34 outputs the thumbnail image data of the printing-ordered image from the stored image data for display to the writing device 36.

When the image specifying information and the thumbnail image data are written into the scene marker, the user takes the scene marker to the place where the receiving machine 38 is installed. Then, the user inputs the information for instructing the printing order via the input section 76 of the receiving machine 38. In this way, the external I/F section 78 of the receiving machine 38 reads out the image specifying information, the user information and the thumbnail image data from the storage section 50 of the scene marker possessed by the user (see step 105 in FIG. 4).

The receiving machine 38 displays a thumbnail image on the display section 74 using the thumbnail image data read out from the scene marker (see step 108 in FIG. 4). Thus, the thumbnail image can be displayed on the display section 74 without the image order processing device 12 (or the content provider) sending the thumbnail image data. Further, as the user who has inputted the information for instructing the printing order can confirm the image that the user himself is ordering to be printed, an amount of data that should be sent and received between the receiving machine 38 and the image order processing device 12/content provider can be reduced.

The printing ordering sequence after displaying the thumbnail image data is substantially the same as the printing ordering sequence shown in FIG. 3, and thus a description thereof will be omitted. When obtaining the thumbnail image data is omitted as described above, the image order processing device 12 has not received the print order (i.e., has not stored the receipt information), at the time when the user confirms the thumbnail image displayed on the display section 74 and inputs the information which represents details of the contents of the printing order and the image order processing device 12 receives the information. Further, a usage fee for the printing-ordered image is unknown except the case in which the data of the printing-ordered image has been already stored in the image DB.

In the image order receiving and delivering processing (FIGS. 6A through 6C) performed by the image order processing device 12, when the above-described case occurs, the determination in step 202 is affirmative and then the receipt number is attached (step 204) and the receipt information is stored (step 206). The answer to the determination in step 220 is affirmed and the process proceeds to step 222. As the above-described step 212, the content provider (or administrator), which stores the image data of the printing-ordered image, is identified. Thereafter, in step 224, the image specifying information and the receipt number are attached to the information, which represents an request for the image usage fee. Then, the resulting information is sent to the content provider (or administrator), which is identified in step 222 to request the usage fee for the printing-ordered image. A processing (step 226) for calculating a print fee is carried out by using the image usage fee, which is informed from the content provider (or administrator).

[Print Ordering Sequence by the Second Ordering Method]

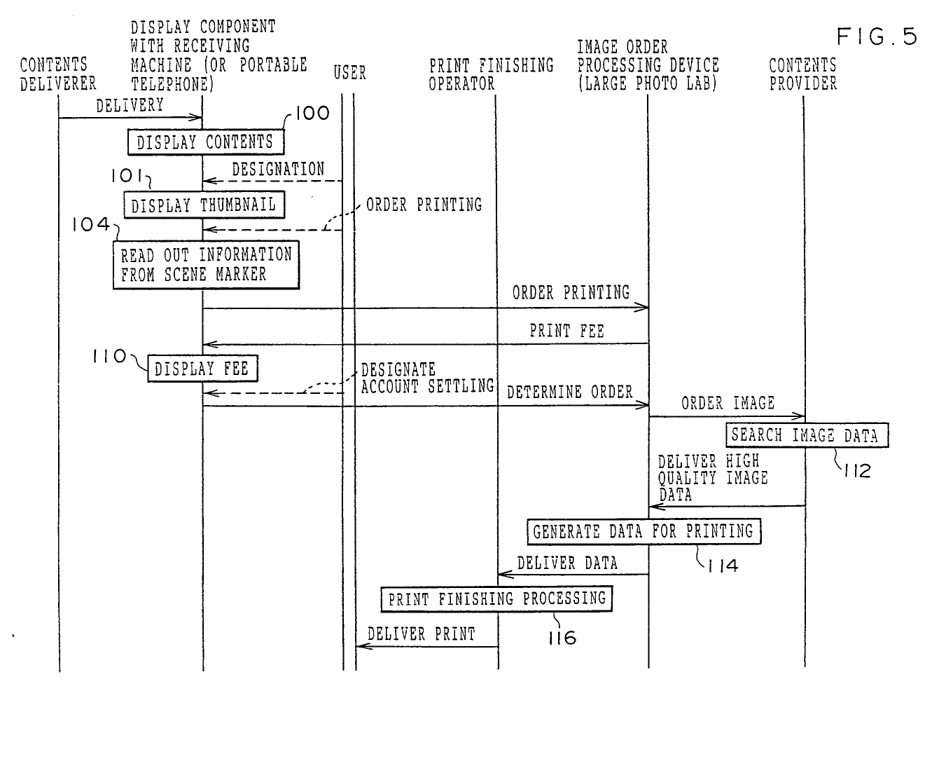

Next, an example of a printing ordering sequence by the second ordering method will be described with reference to FIG. 5. Here, only the portions that differ from the above-described printing ordering sequence will be described.

The printing ordering by the second ordering method is performed in a case in which an image that a user would like to memorize by storing as a photographic print is displayed on the display component 34B having the receiving machine 40 (e.g., the receiving machine 40A or 40B shown in FIG. 1) built therein or provided (or an electronic equipment having a function of the display component or the receiving machine (e.g., a portable telephone or a PC indicated by a reference numeral “40C”): hereinafter this will be referred to as the display component 34B). A user inputs the information for designating the image to be printed via the input section of the receiving machine 40 or the like.

The receiving machine 40 obtains the image specifying information and the thumbnail image data like the writing device 36 in the printing ordering sequence shown in FIG. 4, so that the thumbnail image is displayed on the display section of the receiving machine 40 (see step 101 in FIG. 5). Thus, the thumbnail image can be displayed on the display section without the image order processing device 12 (and the content provider) sending the thumbnail image data. The user who has inputted the information for instructing the printing order can confirm the image that the user himself has ordered to be printed. Thus, an amount of data that should be sent and received between the receiving machine 40 and the image order processing device 12/content provider can be reduced.

The receiving machine 40 is built in or provided at the display component 34B. Therefore, in most cases, a time when the user inputs the information for designating the image to be printed is the time when the image that the user would like to store as a photographic print is being displayed on the display component 34B or the time immediately thereafter. Thus, displaying the thumbnail image may be omitted.

The user confirms the thumbnail image displayed on the display section 74 and inputs the information which represents details of the contents of the printing order such that the contents of the printing order desired by the user are determined. Then, the external I/F section 78 of the receiving machine 40 reads out the user information from the storage section 50 of the scene marker possessed by the user (see step 104 in FIG. 5). The receiving machine 40 attaches the information which represents the determined contents of the printing order, the obtained image specifying information, the user information which is read out from the storage section 50 of the scene marker and the receiving machine ID for identifying the receiving machine 38 to the information which represents the printing order, and sends the resultant information to the image order processing device 12. The printing ordering sequence after this sending of the resultant information is substantially the same as the printing ordering sequence shown in FIG. 4, and thus the description thereof will be omitted.

In the above-described second ordering method, as the receiving machine 40 sends the information to the image order processing device 12 without writing in the obtained image specifying information, the information which is read out in step 104 in FIG. 5 is only the user information. The user information may be inputted by a user via the input section of the receiving machine 40. Consequently, in the second ordering method, the user need not to have a scene marker, and even if the user has only a simple recording medium with only the user information being written therein (e.g., a magnetic card or a card with a barcode being recorded therein: the card may enable accounting like a credit card) or the user does not have the scene marker or the simple recording medium, the printing order can be performed.

When the user does not have the scene marker or other simple recording medium, the user must input the user information for each printing order such that a great burden is placed on the user. When the user has only the simple recording medium, the user information may be read out or forged by a malicious third party. For this reason, the user preferably has a card type scene marker or a scene marker, which is built in a portable telephone.

[Specific Examples of Business Model]

Specific examples of business model realized by the image delivery/order processing system 10 relating to the present embodiments will be described for each of various image content. Models that will be described hereinafter are merely examples, and the invention is not limited to the following models.

Model (1): Image of Moving Scenes in Sports Event

A professional photographer who is a content provider shoots impressive scenes such as a highlight play, a big home run and a goal scene at a stadium where a sports event is held. Then, the photographer brings (e.g., transfers on-line) the image data of the shot scenes to an administrator (e.g., content deliverer) who administrates an electronic signboard (i.e., display component) placed at the stadium in order to provide a user with the shot impressive scenes and obtain values for the image data. The administrator for the electronic signboard displays the data brought by the professional photographer on the electronic signboard as images of moving scenes in order to receive timely printing orders. In this way, images of moving scenes are displayed for users at the stadium.

A user who finds, among the images displayed on the electronic signboard, an image that the user would like to store by storing it as a photographic printing orders the image to be printed by the first ordering method using the writing device 36 which is provided at or built in the electronic signboard and the receiving machine 38 which is provided separately from the electronic signboard. Alternatively, the user orders the image to be printed by the second ordering method using the receiving machine 40 which is provided at or built in the electronic signboard (or a portable telephone which is possessed by a user and has a function of the receiving machine).

When a processing such as a display of fee or the like is carried out and then the printing order is determined, high quality image data of the printing-ordered image is transferred from the content provider (or administrator). Thus, a photographic print formed by this image data is delivered to the user. When the printing order is determined, a settlement processing is performed. A usage fee for the printing-ordered image is paid to the content provider (administrator), and the content deliverer obtains compensation for the image content delivery.

Examples of other image content applicable to model (1) include images of works shot by a professional photographer, who is a content provider, at an art museum where shooting by ordinary people is prohibited (the images are delivered to users (i.e., visitors of the art museum) by displaying the images on an electronic signboard placed at, for example, an exit of the art museum) and images of exciting live scenes shot by a professional photographer, who is the content provider, at a live show (the images are delivered to users (i.e., the audience of the live show) by displaying the images at the end of the live show on an electronic signboard placed at, for example, an exit of a hall).

Model (2): Image of Digital Broadcasting

A program, which is produced by a producer who is a content provider, is brought into a broadcasting station (i.e., content deliverer) for the digital broadcasting, and is delivered by the broadcasting station. The user receives the digital broadcasting with an electronic equipment having a function of receiving digital broadcasting, such as a television, a PC or the like. Thus, moving images of the digital broadcasting are displayed on a display of the electronic equipment (i.e., display component).

A user who finds, among the moving images of the digital broadcasting displayed on the display of the electronic equipment, a scene that the user would like to keep by storing it as a photographic printing orders the scene to be printed with the first ordering method that uses the writing device 36, which is built in or provided at the electronic equipment, and the receiving machine 38 which is provided separately from the electronic equipment. Alternatively, the user orders the scene to be printed with the second ordering method that uses the receiving machine 40, which is built in or provided at the electronic equipment (or a portable telephone possessed by the user that functions as the receiving machine). Sequences subsequent to the printing order are the same as in model (1) and descriptions thereof will be omitted.

In model (2), the image content to be delivered are not limited to the moving images, and still images may be delivered. In accordance with multi-channel accompanying start of digital broadcasting, channels for broadcasting data such as excellent still image content (for example, works of famous illustrator, space planet photographs shot by Subaru and still images of travel scenes such as “The approach to the Kiyomizu Temple just after the rain in autumn Kyoto” and “Ropes stretched from the top of a pine tree to branches at Kanazawa Kenrokuen in late autumn” may be provided. In a case of the digital broadcasting, the same scene can be broadcasted by multi-angle. In the multi-angle, a single scene can be viewed from a plurality of different directions. By broadcasting still image content with the multi-angle, the user can order an image of a scene with an angle that the user likes to be printed.

When ordering prints by the first ordering method in model (2), the function of the writing device 36 may be built in a remote controller for controlling home electric equipment such as a television or the like. When a user performs an operation for designating an image to be printed via a key of the remote controller, the remote controller writes the information such as image specifying information into a scene marker.

Model (3): Image of Souvenir Photograph Shot at Fixed Point such as Tourist Spot

A fixed point unmanned camera (DSC) is disposed at places in tourist spots that are frequently selected as backgrounds for souvenir photographs. The user visits a tourist spot without a camera and shoots a souvenir photograph (of the user himself) using the fixed point unmanned camera. An automatic photographing function of the fixed point unmanned camera may be utilized. Alternatively, a scene marker may function as a remote controller to take the photograph of the fixed point unmanned camera.

Several methods are provided for ordering prints of images of souvenir photographs shot at a fixed point by a fixed point unmanned camera. In accordance with a first method, a display component (e.g., a display such as an electronic signboard or the like), which is built into or provided at a fixed point, unmanned camera displays an image of souvenir photograph shot at a fixed point. Then, similar to model (1), a user orders the image of the souvenir photograph shot at the fixed point to be printed by the first ordering method or the second ordering method.

In accordance with a second method, a function as the writing device 36 is incorporated into a fixed point unmanned camera. When an image is shot by a designation of user, the fixed point unmanned camera writes code information (which may comprise information such as information for identifying the fixed point unmanned camera, a frame number, a place of the shooting and a data of the shooting) for identifying the shot image into a scene marker possessed by the user (the thumbnail image data may also be written). In accordance with this method, printing ordering may be performed by the first ordering method.

A third method may be applied when a storage capacity of scene marker is large. Instead of the code information of the second method, the image data (high quality image data or data obtained by compressing the high quality image data) is written into the scene marker. In accordance with the third method, printing ordering can also be performed by the first ordering method (Here, transferring the high quality image data from a content provider is not necessary).

In accordance with a fourth method, images of souvenir photographs shot at a fixed point are disclosed on a computer network which is easily accessible by the user (for example, the images are disclosed on a web page of a person who places a fixed point unmanned camera (i.e., content provider/deliverer) which is created on a specified web server of the Internet). Then, a user accesses the computer network via an electronic equipment such as a PC or a portable telephone so as to see and confirm the shot souvenir photographs, and to orders prints thereof. This method can perform print ordering using the second method. When a password for enabling watching of the images or the like is given to a user at a time of shooting, the user can see the images by inputting the informed password. Thus, even if the images of the shot souvenir photographs are disclosed on a computer network, a privacy of user can be ensured.

Model (4): Image of Children's School Life

Parents have a few opportunities to see their children's school life. For this reason, a local photographer goes to the children's school and shoots pictures of an athletic competition, a concert, a school picnic and classes. Alternatively, the photographer lends inexpensive DSCs and the children freely shoot photographs with them. In this way, images of children's school life (i.e., images which show an ordinary days for the children) can be collected.

The images that are photographed or collected by the above-described manner can be provided to users (the parents of the children) by being displayed on an electronic signboard established by a print finishing operator or a photographer (content provider/deliverer); being disclosed on a computer network which users can easily access (e.g., being disclosed in a web page produced by the print finishing operator or the photographer on a specified web server of the Internet) or being displayed via a receiving machine. A title such as “Athletic Competition at . . . Elementary School” or other characters may be incorporated into each of the images, which are provided to the users. In this case, the users can order prints by the first ordering method or the second ordering method.

Although a case in which the scene marker has a function of settlement is described above, the invention is not limited to this case. A print finishing operator may deliver produced photographic prints as payment on delivery. Alternatively, by going to a shop of the print finishing operator, the user may settle an account in exchange for photographic prints. If the settlement function of scene marker is utilized and an account is settled online at a time when a printing order is determined, the photographic prints can be rapidly provided to the user without exchanging cash, preferable.

Although an aspect in which a user possesses a scene marker (or a recording medium with user information recorded therein) has been described above, the invention is not limited to this aspect. The invention also includes an aspect wherein a user does not have the scene marker. Nevertheless, when a user has the scene marker, there are advantages in that a recipient can be correctly identified when the photographic prints are provided, and even if a place where a user orders the printing is far from a place where the user receives the photographic prints, the photographic prints can be provided to the correct user.

In the image order processing device 12, various services (restoring of points or providing of service information) may be provided to each of the users by using the user information sent from a receiving machine or the like in accordance with a condition of use of the image delivery/order processing system 10.

Although an example in which an image DB is provided only at a large lab (image order processing device 12), the invention is not limited to this example. Especially in an aspect wherein the receiving machine 38 is connected, via the computer 20 of the print finishing operator, to the MI network 16, the image DB may also be provided at the computer 20 of the print finishing operator. Images, which are unique to a local region (e.g., images of children's school life described in model (4) or local festivals) may be stored in the image DB.

In the first ordering method, when the thumbnail image data is delivered from a content provider (or administrator) to the image order processing device 12, the high quality image data (which is preferably encrypted) may also be delivered. Thus, the number of communications between the content provider and the image order processing device 12 can be reduced.

A case in which the user who orders prints is different from the content provider has been described above. Nevertheless, the user who performs the printing ordering may be the same as the content provider. The user may order prints for the images of the image content provided by the user himself (e.g., images shot by the user himself).

For example, as currently realized in a portable telephone, the user borrows in advance a DSC with which the user can photograph a predetermined number of images. The predetermined number of images corresponds to a rental fee paid in advance by the user (i.e., a prepaid DSC). The user photographs a predetermined number of images with the prepaid DSC, then returns the prepaid DSC. A prepaid DSC operator reads out the image data recorded in the returned prepaid DSC and discloses the data as images on a computer network (e.g., discloses the images in a web page produced by the prepaid DSC operator himself on a specified web server of the Internet) such that the image can be viewed via a receiving machine. In this way, the images are provided to the user who rents the prepaid DSC. A user can order prints of the images shot by the user himself by the first ordering method or the second ordering method.

A communication speed of a portable telephone is being increased. For example, a next generation to a third generation portable telephone, i.e., an IMT2000 will be a fourth generation portable telephone system that has a communication speed which is more than 1000 times faster than that of the third generation portable telephone system, i.e., has a communication speed of a several tens Mbps (which is average for an optical fiber). A portable telephone with an increased speed can easily be made to function as a scene marker. Further, transfer of high quality image data can be performed in a short time. A compact CCD camera which is built into a third generation portable telephone has a reduced number of pixels and thus is not suitable for producing a high quality photographic print. When a high quality DSC with a larger number of pixels is connected to the portable telephone and the high quality image data obtained by a user photographing images with the DSC is transferred via the portable telephone to the image order processing device 12, ordering of prints can be performed. Instead of connecting the DSC to the portable telephone to transfer the image data, a recording medium having the high quality image data recorded by photographing with the DSC stored therein may be incorporated into the portable telephone. Thus, the high quality image data can be transferred.

What is claimed is:

1. An image ordering system comprising:
an image ordering component for being used by a customer to order prints;
an image content service system for including image data;
an image processing component for generating image printing data from the image data;
a plurality of image printing systems for printing the image printing data, which image printing systems are connected to a network; and
an image order processing device, the image order processing device including
a reception and received order processing component for receiving image printing order information which is sent when the customer orders prints from the image ordering component;
an image data obtaining component for obtaining, based on the image printing order information, image data of an image that is ordered to be printed from the image content service system; and
a send processing component for selecting an optimal image printing system from the plurality of image and sending at least one of image data obtained by the image data obtaining component and the image printing data generated by the image processing component to the optimal image print system together with received order processing information which represents the contents of a received printing order,
wherein the image ordering component, the image content service system, the image processing component, the image printing systems and the image order processing device are connected to the network.

2. An image order processing device, for being connected to a network having an image ordering component, an image contents service system, a plurality of image printing systems, and an image processing system connected thereto, the image order processing device comprising:
a reception and received order processing component for image printing ordering information from an image ordering component by a customer performing print ordering via the image ordering component;
an image data obtaining component for obtaining, based on the image print ordering information, image data for the printing-ordered image from the image content service system; and
a sending component for selecting an optimal image printing system from among the plurality of image printing systems and sending received order processing information expressing contents of the printing-ordered image and at least one of the obtained image data and print image data generated by the image processing component from the obtained image data.

3. The image order processing device of claim 2, wherein the reception and received order processing component performs at least one of a fee indicating processing for indicating a fee for the print order to a customer via the image order component and a settlement processing for settling the fee for the print order.

4. The image order processing device of claim 2, wherein the image printing order information includes customer information for indicating a customer who ordered prints, and the reception/received order processing component stores the customer information in a customer information storage component.

5. The image order processing device of claim 2 further comprising a copyright managing component for performing a processing for managing the copyright of the printing-ordered image.

6. The image order processing device of claim 5, wherein the copyright managing component adds, in units of predetermined time period compensation, which should be paid to each of the copyright holders in accordance with at least one of a use of the images that received the print order and a usage quantity for each of the images that received the print order, and performs a copyright fee settling process for paying said compensation to each of the copyright holders based on the added information.

7. The image order processing device of claim 2, wherein:
the image data obtaining component obtains original image data and thumbnail image data for each of the printing-ordered images, and
the reception and received order processing component instructs the image ordering component to perform a processing for allowing a customer to re-confirm the printing ordered image by sending the thumbnail image data to the image order component.

8. The image order processing device of claim 2, wherein the image data obtaining component selects, based on the information included in the image printing order information, which information is for specifying the printing-ordered image, the image content service system that is storing the data of the ordered image, and specifies the printing-ordered image.

9. The image order processing device of claim 2, wherein the image data obtaining component instructs the image data storage component to store the obtained image data.

10. The image order processing device of claim 2, wherein the image data obtaining component performs at least one of decompression of obtained compressed image data and decoding of obtained encrypted image data when the obtained image data has been subjected to at least one of compression and encryption.

11. The image order processing device of claim 2, wherein the image processing component generates the print image data by performing at least one of an image processing for image quality enhancement and a resolution conversion on the obtained image data.

12. The image order processing device of claim 2, wherein the image processing component generates the print image data by performing at least one of editing and synthesis of the obtained image data in accordance with the contents of the received printing order.

13. The image order processing device of claim 2, wherein the send processing component performs at least one of compression and encryption on the image data to be sent to the selected optimal image printing system.

14. An image order processing method comprising the steps of:
(a) connecting each of at least one of a plurality of image content service systems possessed by at least one of a plurality of content providers and a plurality of content deliverers and a plurality of image printing systems possessed by a plurality of image print finishing operators an image order processing device via a network;
(b) making the image order processing device gather all printing orders ordered by customers watching the image content, which is delivered by one of the content provider and the content deliverer, through the image ordering component connected to the network to the image order processing device by sending, for each time a printing order occurs, the image printing order information containing the information for specifying the printing-ordered image from the image ordering component; and
(c) in the image order processing device,
obtaining image data for the printing-ordered image by selecting an image contents service system, which is storing ordered image data and specifying a printing-ordered image,
selecting the optimal image printing system among the plurality of image printing systems, and
making an image print finisher processing the optimal image printing system print the printing-ordered image by sending received order processing information which expresses contents of a received printing order and at least one of the obtained image data and printing image data generated from the obtained image data to the selected optimal image printing system.

15. The method of claim 14, wherein:
the image printing order information includes at least one of operator designating information which represents a specified image print finishing operator designated by a customer via the image ordering component and customer information which represents the customer who ordered prints, and
at least one of the image printing system possessed by the image print finishing operator expressed by the operator designating information and the image printing system possessed by the image print finishing operator nearest to the customer, which is selected on a basis of the customer information, is selected as the optimal image printing system.

16. The method of claim 14, wherein the image content delivered by one of the content provider and the content deliverer is one of still images and moving images photographed by one of a professional photographer, a news photographer, an amateur photographer and a camera without operator, still images and moving images of one of television broadcasting and data broadcasting, any image content including moving images of network live performance delivered through a computer network and films, and the image of the image content is ordered to be printed by a customer.

17. The method of claim 14, wherein the information for specifying the printing-ordered image comprises at least one of information for identifying at least one of the content provider and the content deliverer, the information for identifying a display component which displays the printing ordered image content, information indicating a date of broadcasting and at least one of a television broadcasting program and a data broadcasting program, at least one of the time information and a time code for specifying the printing-ordered image in the moving images or a film serving as the image content and information for identifying a delivery origin delivering the image content via a computer network.

18. The method of claim 14, wherein the image order processing device further comprising a substep of performing at least one of a fee indicating processing for indicating a fee for the printing order to a customer and a settlement processing for settling a fee for the printing order.

19. The image order processing method of claim 14, wherein the image order processing device further comprising a substep of performing a processing for managing the copyright of the printing-ordered image.

20. The method of claim 19, further comprising a step of adding, in units of a predetermined time period, compensation, which should be paid to each of the copyright holders in accordance with at least one of a use of the images that received the print order and a usage quantity for each of the images that received the print order, and performing a copyright fee settling process for paying said compensation to each of the copyright holders based on the added information.
